SEQUENCE LISTING (14 sequences)

SEQ ID NO: 1 - DNA, 38 bp, Artificial Sequence
  Synthetic sequence
ggtggttctgctagggcccaggcggcctgcggtggcgg

SEQ ID NO: 2 - DNA, 38 bp, Artificial Sequence
  Synthetic sequence
ccgccaccgcaggccgcctgggccctagcagaaccacc

SEQ ID NO: 3 - DNA, 39 bp, Artificial Sequence
  Synthetic sequence
caggtcgactgcggccaggccggccaagggggcggatcc

SEQ ID NO: 4 - DNA, 39 bp, Artificial Sequence
  Synthetic sequence
ggatccgcccccttggccggcctggccgcagtcgacctg

SEQ ID NO: 5 - protein, 50 aa, Human immunodeficiency virus
LEADAGGVHSLIEESQNQQEKNEQELLELDKWASLWNWFNITNWPPPAGA

SEQ ID NO: 6 - protein, 38 aa, Human immunodeficiency virus
LEADAGGVIEESQNQQEKNEQELLELDKWASLSPPAGA

SEQ ID NO: 7 - protein, 38 aa, Human immunodeficiency virus; identical to SEQ ID NO: 6

SEQ ID NO: 8 - protein, 50 aa, Human immunodeficiency virus; identical to SEQ ID NO: 5

SEQ ID NO: 9 - protein, 50 aa, Human immunodeficiency virus; identical to SEQ ID NO: 5

SEQ ID NO: 10 - protein, 38 aa, Human immunodeficiency virus; identical to SEQ ID NO: 6

SEQ ID NO: 11 - DNA, 42 bp, Artificial Sequence
  Synthetic sequence
gggcaagtttgtggaattggtttgacataacaaattggccac

SEQ ID NO: 12 - DNA, 42 bp, Artificial Sequence
  Synthetic sequence
gtggccaatttgttatgtcaaaccaattccacaaacttgccc

SEQ ID NO: 13 - protein, 7 aa, Human immunodeficiency virus
WNWFNIT

SEQ ID NO: 14 - protein, 7 aa, Artificial Sequence
  Synthetic seuqence
WNWFDIT

(19) United States
(12) Patent Application Publication
(10) Pub. No.: US 2010/0210473 A1
(43) Pub. Date: Aug. 19, 2010

(54) Methods and compositions for identifying binding partners from libraries of biomolecules

(75) Inventors: Diana R. Bowley, San Diego, CA (US); Teresa Jones, San Diego, CA (US); Dennis R. Burton, La Jolla, CA (US); Richard A. Lerner, La Jolla, CA (US)

Correspondence Address: THE SCRIPPS RESEARCH INSTITUTE, OFFICE OF PATENT COUNSEL, TPC-8, 10550 NORTH TORREY PINES ROAD, LA JOLLA, CA, 92037, US

(73) Assignee: The Scripps Research Institute, La Jolla, CA (US)

(21) Appl. No.: 12/657,085

(22) Filed: Jan. 12, 2010

Related U.S. Application Data
(60) Provisional application No. 61/204,975, filed on Jan. 12, 2009.

(51) Int. Cl. C40B 30/04; C40B 40/10; C40B 40/08

(52) U.S. Cl. 506/9; 506/18; 506/17

(57) ABSTRACT

The present invention provides methods for identifying cognate binding pairs from two libraries of biomolecules (e.g., polypeptides). The methods typically involve displaying a first library of candidate biomolecules (e.g., receptors or epitopes) on a first replicable genetic package (e.g., a cell surface display platform) and displaying a second library of candidate biomolecules (e.g., ligands) on a second replicable genetic package (e.g., a phage display platform), contacting the first library with the second library, and then selecting members of the first library to which a member of the second library is bound. Also provided in the invention are compositions and kits for carrying out the methods of the invention.

### CROSS-REFERENCE TO RELATED APPLICATION

This application claims the benefit of priority under 35 U.S.C. 119(e) to U.S. Provisional Application Ser. No. 61/204,975, filed Jan. 12, 2009. Disclosure of the foregoing application is hereby incorporated by reference herein in its entirety and for all purposes.

### STATEMENT OF GOVERNMENT SUPPORT

This invention was made in part by government support by the National Institutes of Health Grant Nos. AI33292, AI52057, AI55332, AI060425, AI056375, AI004243 and AI065359. The U.S. Government therefore has certain rights in the invention.

### BACKGROUND OF THE INVENTION

The introduction of phage display of antibodies has changed the face of the pharmaceutical industry by making the discovery and optimization of antibodies routine. The more recent development of eukaryotic display of antibodies has also significantly contributed to the rate of discovery, optimization and characterization of antibodies. However a major limitation is the need to have purified antigen for selection. Alternatively intact cells can be used for selecting antibodies. However, with such an approach, identity of the antigen is unknown. As a result, after selecting an antibody, it must be purified in order to identify the antigen.

There is a need in the art for better and more robust means for identifying specific cognate binding partners (e.g., antibodies and antigens) from pools of candidate biomolecules. The present invention is directed to this and other needs.

### SUMMARY OF THE INVENTION

In one aspect, the invention provides methods for simultaneously identifying multiple binding partners from two cognate libraries of candidate biomolecules. The methods entail (a) displaying (e.g., expressing) a first library of candidate biomolecules in a first library of replicable genetic package; (b) display (e.g., expressing) a second library of candidate biomolecules in a second library of replicable genetic package; (c) contacting the first library of replicable genetic package with the second library of replicable genetic package; and (d) identifying members of the first library of replicable genetic package to which a member of the second replicable genetic package is bound. Typically, each library of candidate biomolecules employed in the methods contains at least 10 members. In some methods, each library contains at least 10², 10³, 10⁴, 10⁵, 10⁶, 10⁷, or 10⁸ members. In some preferred embodiments, the libraries of candidate biomolecules utilized in the methods are polypeptides. Some of these methods involve further determining nucleotide sequences of polynucleotides which encode the polypeptides expressed in the identified members of the replicable genetic packages.

In some methods, the libraries of candidate biomolecules are expressed as fusion proteins to a package surface protein. Some of the methods employ a first library of replicable genetic package that is a cell based display platform, and a second library of replicable genetic package that is a non-cell based display platform. In some of these methods, the first library of replicable genetic package is a yeast surface display library, and the second library of replicable genetic package is a phage display library. The phage used in these methods can be, e.g., a filamentous phage such as M13, fd, fl, and an engineered variant phage.

Some methods of the invention are directed to selecting a library of antibodies or antigen-binding fragments against a library of antigens. In these methods, the library of antibodies or antigen-binding fragments can be, e.g., single chain variable region fragments (scFvs), single domain antibodies (dAbs), Fab fragments, F(ab′)₂ fragments, Fv fragments or Fd fragments. In some of the methods, one library is displayed in a cell based display platform, and the other library is displayed in a non-cell based display platform. For example, the cell based display platform can be yeast surface display, and the non-cell based display platform can be phage display. In some methods, a library of antigens is displayed on yeast surface, and a library of antibodies is displayed on phage. In some other methods, a library of antibodies is displayed on yeast surface, and a library of antigens is displayed on phage.

Some methods of the invention employ a library of candidate antibodies that are human antibodies. For example, the antibody library can be a naïve human antibody library. In some other methods, a library of murine antibodies is used. In some methods, the library of antigens used in the screening contains antigens obtained from bone marrow cells. For example, the library of antigens can be antigens encoded by a cDNA library from bone marrow cells. In some other methods, a library of antigens obtained from a tumor cell is employed. Such antigens can be prepared from, e.g., a cDNA library from the tumor cell such as a cDNA library encoding surface proteins of the tumor cell.

In a related aspect, the invention provides screening systems for simultaneously identifying multiple binding partners from two cognate libraries of candidate biomolecules. The screening systems typically contain (a) a first library of candidate biomolecules displayed in a first replicable genetic package; and (b) a second library of candidate biomolecules displayed in a second replicable genetic package. In the screening systems, each library of candidate biomolecules typically harbors at least 10 different members. In some systems, at least 10², 10³, 10⁴, 10⁵, 10⁶, 10⁷, or 10⁸ different members are present in each library of candidate biomolecules.

Some of the screening systems are intended to identify binding pairs from two libraries of candidate polypeptides. For example, the first library of candidate biomolecules can be antibodies or antigen-binding fragments, and the second library of candidate biomolecules can be polypeptide antigens. The candidate antibodies employed in these screening systems can be, e.g., single chain variable region fragments (scFvs), single domain antibodies (dAbs), Fab fragments or F(ab′)₂ fragments. In some of these systems, the candidate antibodies are naïve human single chain antibodies. Some of these systems employ a library of candidate biomolecules that are antigens encoded by a cDNA library of bone marrow cells. In some other systems, the library of candidate antigens contains antigens encoded by a cDNA library of a tumor cell. In some screening systems of the invention, one of the employed replicable genetic package systems is phage, and the other is yeast.

In another aspect, the invention provides kits that can be used in simultaneously identifying multiple binding partners from two cognate libraries of biomolecules. The kits usually contain (a) a first vector for displaying a first library of candidate biomolecules in a first replicable genetic package; and (b) a second vector for display a second library of candidate biomolecules in a second replicable genetic package. Some of the kits additionally contain an instruction for selecting the first library against the second library to identify binding partners. For example, the instruction can provide one or more of the following: (i) a protocol for contacting the first library with the second library; (ii) a protocol for identifying a member of the first library specifically bound by a member of the second library; and (iii) a protocol for separating the bound members. Some kits of the invention also contain a first host cell for expressing the first vector and a second host cell for expressing the second vector.

Some of the kits are intended to be used for identifying polypeptide binding partners, e.g., antibody-antigen binding pairs. Such kits are useful for identifying binders from a library of antibodies, e.g., single chain variable fragments (scFvs), single domain antibodies (dAbs), Fab fragments or F(ab′)₂ fragments. In some kits of the invention, the first vector is a phage display vector (e.g., a phagemid vector), and the second vector is a yeast display vector.

A further understanding of the nature and advantages of the present invention may be realized by reference to the remaining portions of the specification and claims.

### BRIEF DESCRIPTION OF THE DRAWINGS

FIG. 1 is a schematic illustration of the strategy employed for identification of antibody-antigen pairs with library-against-library selection. A library of antigens (or antibodies) is displayed on phage and a library of antibodies (or antigens) is displayed on yeast. The two libraries are mixed and phage that are not bound to yeast cells are washed away. Phage that are bound to yeast cells are labeled with a fluorescence reagent and flow cytometry sorting is utilized to select yeast cells bound to phage. The yeast and phage are separated for amplification and the selection round is repeated until significant enrichment of pairs has been achieved. During the final round of selection, single cells of phage-positive yeast are sorted into 96-well plates. By eluting the phage from a single yeast cell, the information link between the platforms is maintained and clonal pairs of antigens and antibodies are isolated.

FIGS. 2A-2D show yeast-displayed Z13e1 scFv binding to phage in FACS bivariate plots. Shown in panel A are secondary antibody only controls, in panel B phage-fragment TJ7 (WNWFNIT) (SEQ ID NO:13) and panel C phage-fragment TJ7.15 (WNWFDIT) (SEQ ID NO:14). Panel D shows binding to biotinylated-M41xt (obtained during a separate experiment on a different instrument). The x-axis of the FACS bivariate plots indicates display of the scFv on the surface of the yeast cells (as measured by fluorescent a-HA antibody), and the y-axis shows binding of the yeast cells to phage (measured by fluorescent anti-phage antibody α-M13).

FIG. 3 summarizes results from 5 rounds of selection of Z13e1-TJ7.15 binding pairs with the yeast displayed antibody library and the phage displayed antigen library.

### DETAILED DESCRIPTION OF THE INVENTION

### I. Definitions

Unless defined otherwise, all technical and scientific terms used herein have the same meaning as commonly understood by those of ordinary skill in the art to which this invention pertains. The following references provide one of skill with a general definition of many of the terms used in this invention: Academic Press Dictionary of Science and Technology, Morris (Ed.), Academic Press (1^{st} ed., 1992); Oxford Dictionary of Biochemistry and Molecular Biology, Smith et al. (Eds.), Oxford University Press (revised ed., 2000); Encyclopaedic Dictionary of Chemistry, Kumar (Ed.), Anmol Publications Pvt. Ltd. (2002); Dictionary of Microbiology and Molecular Biology, Singleton et al. (Eds.), John Wiley & Sons (3^{rd} ed., 2002); Dictionary of Chemistry, Hunt (Ed.), Routledge (1^{st} ed., 1999); Dictionary of Pharmaceutical Medicine, Nahler (Ed.), Springer-Verlag Telos (1994); Dictionary of Organic Chemistry, Kumar and Anandand (Eds.), Anmol Publications Pvt. Ltd. (2002); and A Dictionary of Biology (Oxford Paperback Reference), Martin and Hine (Eds.), Oxford University Press (4^{th} ed., 2000). In addition, the following definitions are provided to assist the reader in the practice of the invention.

The term “antibody” or “antigen-binding fragment” refers to polypeptide chain(s) which exhibit a strong monovalent, bivalent or polyvalent binding to a given antigen, epitope or epitopes. Unless otherwise noted, antibodies or antigen-binding fragments used in the invention can have sequences derived from any vertebrate, camelid, avian or pisces species. They can be generated using any suitable technology, e.g., hybridoma technology, ribosome display, phage display, gene shuffling libraries, semi-synthetic or fully synthetic libraries or combinations thereof. Unless otherwise noted, the term “antibody” as used in the present invention includes intact antibodies, antigen-binding polypeptide fragments and other designer antibodies that are described below or well known in the art (see, e.g., Serafini, J Nucl. Med. 34:533-6, 1993).

An intact “antibody” typically comprises at least two heavy (H) chains (about 50-70 kD) and two light (L) chains (about 25 kD) inter-connected by disulfide bonds. The recognized immunoglobulin genes encoding antibody chains include the kappa, lambda, alpha, gamma, delta, epsilon, and mu constant region genes, as well as the myriad immunoglobulin variable region genes. Light chains are classified as either kappa or lambda. Heavy chains are classified as gamma, mu, alpha, delta, or epsilon, which in turn define the immunoglobulin classes, IgG, IgM, IgA, IgD and IgE, respectively.

Each heavy chain of an antibody is comprised of a heavy chain variable region (V_{H}) and a heavy chain constant region. The heavy chain constant region is comprised of three domains, C_{H1}, C_{H2} and C_{H3}. Each light chain is comprised of a light chain variable region (V_{L}) and a light chain constant region. The light chain constant region is comprised of one domain, C_{L}. The variable regions of the heavy and light chains contain a binding domain that interacts with an antigen. The constant regions of the antibodies may mediate the binding of the immunoglobulin to host tissues or factors, including various cells of the immune system and the first component (Clq) of the classical complement system.

The V_{H} and V_{L} regions of an antibody can be further subdivided into regions of hypervariability, also termed complementarity determining regions (CDRs), which are interspersed with the more conserved framework regions (FRs). Each V_{H} and V_{L} is composed of three CDRs and four FRs, arranged from amino-terminus to carboxyl-terminus in the following order: FR1, CDR1, FR2, CDR2, FR3, CDR3, FR4. The locations of CDR and FR regions and a numbering system have been defined by, e.g., Kabat et al., Sequences of Proteins of Immunological Interest, U.S. Department of Health and Human Services, U.S. Government Printing Office (1987 and 1991).

Antibodies to be used in the invention also include antibody fragments or antigen-binding fragments which contain the antigen-binding portions of an intact antibody that retain capacity to bind the cognate antigen. Examples of such antibody fragments include (i) a Fab fragment, a monovalent fragment consisting of the V_{L}, V_{H}, C_{L} and C_{H1} domains; (ii) a F(ab′)₂ fragment, a bivalent fragment comprising two Fab fragments linked by a disulfide bridge at the hinge region; (iii) a Fd fragment consisting of the V_{H} and C_{H1} domains; (iv) a Fv fragment consisting of the V_{L} and V_{H} domains of a single arm of an intact antibody; (v) disulfide stabilized Fvs (dsFvs) which have an interchain disulfide bond engineered between structurally conserved framework regions; (vi) a single domain antibody (dAb) which consists of a V_{H} domain (see, e.g., Ward et al., Nature 341:544-546, 1989); and (vii) an isolated complementarity determining region (CDR).

Antibodies suitable for practicing the present invention also encompass single chain antibodies. The term “single chain antibody” refers to a polypeptide comprising a V_{H} domain and a V_{L} domain in polypeptide linkage, generally linked via a spacer peptide, and which may comprise additional domains or amino acid sequences at the amino- and/or carboxyl-termini. For example, a single-chain antibody may comprise a tether segment for linking to the encoding polynucleotide. As an example, a single chain variable region fragment (scFv) is a single-chain antibody. Compared to the V_{L} and V_{H} domains of the Fv fragment which are coded for by separate genes, a scFv has the two domains joined (e.g., via recombinant methods) by a synthetic linker. This enables them to be made as a single protein chain in which the V_{L} and V_{H} regions pair to form monovalent molecules.

Antibodies that can be used in the practice of the present invention also encompass single domain antigen-binding units which have a camelid scaffold. Animals in the camelid family include camels, llamas, and alpacas. Camelids produce functional antibodies devoid of light chains. The heavy chain variable (V_{H}) domain folds autonomously and functions independently as an antigen-binding unit. Its binding surface involves only three CDRs as compared to the six CDRs in classical antigen-binding molecules (Fabs) or single chain variable fragments (scFvs). Camelid antibodies are capable of attaining binding affinities comparable to those of conventional antibodies.

The various antibodies or antigen-binding fragments described herein can be produced by enzymatic or chemical modification of the intact antibodies, or synthesized de novo using recombinant DNA methodologies, or identified using phage display libraries. Methods for generating these antibodies or antigen-binding molecules are all well known in the art. For example, single chain antibodies can be generated using phage display libraries or ribosome display libraries, gene shuffled libraries (see, e.g., McCafferty et al., Nature 348:552-554, 1990; and U.S. Pat. No. 4,946,778). In particular, scFv antibodies can be obtained using methods described in, e.g., Bird et al., Science 242:423-426, 1988; and Huston et al., Proc. Natl. Acad. Sci. USA 85:5879-5883, 1988. Fv antibody fragments can be generated as described in Skerra and Pliickthun, Science 240:1038-41, 1988. Disulfide-stabilized Fv fragments (dsFvs) can be made using methods described in, e.g., Reiter et al., Int. J. Cancer 67:113-23, 1996. Similarly, single domain antibodies (dAbs) can be produced by a variety of methods described in, e.g., Ward et al., Nature 341:544-546, 1989; and Cai and Garen, Proc. Natl. Acad. Sci. USA 93:6280-85, 1996. Camelid single domain antibodies can be produced using methods well known in the art, e.g., Dumoulin et al., Nature Struct. Biol. 11:500-515, 2002; Ghahroudi et al., FEBS Letters 414:521-526, 1997; and Bond et al., Mol. Biol. 332:643-55, 2003. Other types of antigen-binding fragments (e.g., Fab, F(ab′)₂ or Fd fragments) can also be readily produced with routinely practiced immunology methods. See, e.g., Harlow & Lane, Using Antibodies, A Laboratory Manual, Cold Spring Harbor Laboratory Press, Cold Spring Harbor, N.Y., 1998.

A “binding pair member” or “binder” in its various forms refers to a molecule that participates in a specific binding interaction with a binding partner, which can also be referred to as a “second binding pair member” or “cognate binding partner”. The term “binding pairs” or “binding partners” refers to two cognate compounds or molecules which specifically interact with each other. Examples of binding pairs include antibodies/antigens, receptor/ligands, biotin/avidin, and interacting protein domains such as leucine zippers and the like. A binding pair member as used herein can be a binding domain, i.e., a subsequence of a protein that binds specifically to a binding partner.

An “affinity matured” or “improved” binding pair member is one that binds to the same site as an initial reference binding pair member, but has a higher affinity for that site.

Binding affinity is generally expressed in terms of equilibrium association or dissociation constants (Kₐ or K_{d}, respectively), which are in turn reciprocal ratios of dissociation and association rate constants (k_{d} and kₐ, respectively). Thus, equivalent affinities may correspond to different rate constants, so long as the ratio of the rate constants remains the same.

As used herein, the term “biomolecule” or “candidate biomolecule” refers to any molecule that can be expressed and/or displayed with a replicable genetic package system. Biomolecules include, but are not limited to, polylpeptides (e.g., antibodies or antigen-binding fragments), peptides, proteins, amino acids, enzymes, nucleic acids, lipids, carbohydrates, and fragments, homologs, analogs, or derivatives, and combinations thereof. The biomolecules can be native, recombinant, or synthesized, and may be modified from their native form with, for example, glycosylations, acetylations, phosphorylations, myristylations, and the like.

The term “capture molecule” refers to a molecule that is immobilized on a surface. The capture molecule generally, but not necessarily, binds to a target or target molecule or cell. It can also be a compound that recognizes another molecule which binds to a target molecule, e.g., a secondary antibody. The capture molecule is typically a nucleotide, an oligonucleotide, a polynucleotide, a peptide, or a protein, but could also be other substances that are capable of binding to a target molecule. In some embodiments, the capture molecule may be magnetically or fluorescently labeled antibody. In specific embodiments of the invention, the capture molecule may be immobilized on the surface of a magnetic bead.

The term “contacting” has its normal meaning and refers to combining two or more agents (e.g., polypeptides or phage) or combining agents and cells. Contacting can occur in vitro, e.g., mixing two polypeptides or mixing a population of phage with a population of cells in a test tube or other container. Contacting can also occur in a cell or in situ, e.g., contacting two polypeptides in a cell by coexpression in the cell of recombinant polynucleotides encoding the two polypeptides, or in a cell lysate.

A “fusion” protein or polypeptide refers to a polypeptide comprised of at least two polypeptides and a linking sequence or a linkage to operatively link the two polypeptides into one continuous polypeptide. The two polypeptides linked in a fusion polypeptide are typically derived from two independent sources, and therefore a fusion polypeptide comprises two linked polypeptides not normally found linked in nature.

“Heterologous”, when used with reference to two polypeptides, indicates that the two are not found in the same cell or microorganism in nature. Allelic variations or naturally-occurring mutational events do not give rise to a heterologous biomolecule or sequence as defined herein. A “heterologous” region of a vector construct is an identifiable segment of polynucleotide within a larger polynucleotide molecule that is not found in association with the larger molecule in nature. Thus, when the heterologous region encodes a mammalian gene, the gene will usually be flanked by polynucleotide that does not flank the mammalian genomic polynucleotide in the genome of the source organism.

The term “interaction” or “interacts” when referring to the interaction between members of a binding pair refers to specific binding to one another.

A “ligand” is a molecule that is recognized by a particular antigen, receptor or target molecule. Examples of ligands that can be employed in the practice of the present invention include, but are not restricted to, agonists and antagonists for cell membrane receptors, toxins and venoms, viral epitopes, hormones, hormone receptors, polypeptides, peptides, enzymes, enzyme substrates, cofactors, drugs (e.g. opiates, steroids, etc.), lectins, sugars, polynucleotides, nucleic acids, oligosaccharides, proteins, and monoclonal antibodies.

“Linkage” refers to means of operably or functionally connecting two biomolecules (e.g., polypeptides or polynucleotides encoding two polypeptides), including, without limitation, recombinant fusion, covalent bonding, disulfide bonding, ionic bonding, hydrogen bonding, and electrostatic bonding. “Fused” refers to linkage by covalent bonding. A “linker” or “spacer” refers to a molecule or group of molecules that connects two biomolecules, and serves to place the two molecules in a preferred configuration with minimal steric hindrance.

The term “operably linked” when referring to a nucleic acid, refers to a linkage of polynucleotide elements in a functional relationship. A nucleic acid is “operably linked” when it is placed into a functional relationship with another nucleic acid sequence. For instance, a promoter or enhancer is operably linked to a coding sequence if it affects the transcription of the coding sequence. Operably linked means that the DNA sequences being linked are typically contiguous and, where necessary to join two protein coding regions, contiguous and in reading frame.

The term “polynucleotide” or “nucleic acid” as used herein refers to a polymeric form of nucleotides of any length, either ribonucleotides or deoxyribonucleotides, that comprise purine and pyrimidine bases, or other natural, chemically or biochemically modified, non-natural, or derivatized nucleotide bases. Polynucleotides of the embodiments of the invention include sequences of deoxyribopolynucleotide (DNA), ribopolynucleotide (RNA), or DNA copies of ribopolynucleotide (cDNA) which may be isolated from natural sources, recombinantly produced, or artificially synthesized. A further example of a polynucleotide of the embodiments of the invention may be polyamide polynucleotide (PNA). The polynucleotides and nucleic acids may exist as single-stranded or double-stranded. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components. The polymers made of nucleotides such as nucleic acids, polynucleotides and polynucleotides may also be referred to herein as “nucleotide polymers.”

Polypeptides are polymer chains comprised of amino acid residue monomers which are joined together through amide bonds (peptide bonds). The amino acids may be the L-optical isomer or the D-optical isomer. In general, polypeptides refer to long polymers of amino acid residues, e.g., those consisting of at least more than 10, 20, 50, 100, 200, 500, or more amino acid residue monomers. However, unless otherwise noted, the term polypeptide as used herein also encompass short peptides which typically contain two or more amino acid monomers, but usually not more than 10, 15, or 20 amino acid monomers.

Proteins are long polymers of amino acids linked via peptide bonds and which may be composed of two or more polypeptide chains. More specifically, the term “protein” refers to a molecule composed of one or more chains of amino acids in a specific order; for example, the order as determined by the base sequence of nucleotides in the gene coding for the protein. Proteins are essential for the structure, function, and regulation of the body's cells, tissues, and organs, and each protein has unique functions. Examples are hormones, enzymes, and antibodies. In some embodiments, the terms polypeptide and protein may be used interchangeably.

Unless otherwise noted, the term “receptor” broadly refers to a molecule that has an affinity for a given ligand. Receptors may-be naturally-occurring or manmade molecules. Also, they can be employed in their unaltered state or as aggregates with other species. Receptors may be attached, covalently or noncovalently, to a binding member, either directly or via a specific binding substance. Examples of receptors which can be employed by this invention include, but are not restricted to, antibodies, cell membrane receptors, monoclonal antibodies and antisera reactive with specific antigenic determinants or epitopes (such as on viruses, cells or other materials), drugs, polynucleotides, nucleic acids, peptides, cofactors, lectins, sugars, polysaccharides, cells, cellular membranes, and organelles. Receptors are sometimes referred to in the art as anti-ligands.

The term “replicable genetic package” or “replicable genetic package system” as used herein refers to a cell, a spore, a phage or a eukaryotic virus (a display medium) on the surface of which an exogenous biomolecule (i.e., one that is not naturally present thereon) is displayed. The replicable genetic package can be eukaryotic or prokaryotic. The exogenous biomolecule (e.g., a peptide or a polypeptide) is usually obtained from an organism or species that is different from the display medium (i.e., being heterologous) or artificially generated (e.g., a recombinant polypeptide such as a single chain antibody fragment). It can also be obtained from the same species as the display medium (i.e., homologous) but has been altered in vitro or ex vivo (e.g., recombinantly generated fragments or mutated variants of a natural polypeptide). The exogenous biomolecule is usually displayed on the display medium via a non-native linkage to a coat protein or outer surface protein of the display medium (a “package surface protein”).

Preferably, a display library of replicable genetic package is formed by introducing polynucleotides encoding exogenous polypeptides or peptides to be displayed into the genome of the display medium to form a fusion protein with an endogenous package surface protein that is normally expressed and present on the outer surface of the display medium. Expression of the fusion protein, transport to the outer surface and assembly results in display of exogenous polypeptides from the outer surface of the genetic package. Unless otherwise noted, the term “replicable genetic package” or “replicable genetic package system” is used interchangeably with the term “display platform.”

The term “stringency” refers to the conditions of a binding reaction between two cognate binding partners (e.g., an antibody and an antigen) that influence the degree to which the two molecules interact with each other. Stringent conditions can be selected that allow high affinity binders to be distinguished from low affinity binding pairs and non-specific interactions. High stringency is correlated with a lower probability for an antibody and an antigen to form a complex. Thus, the higher the stringency, the greater the probability that only high affinity antibody-antigen binding pairs will be isolated. Conversely, at lower stringency, the probability of formation of antibody-antigen complex from low affinity binding pairs is increased. The appropriate stringency that will allow selection of high affinity or low affinity antibody-antigen binding pairs is generally determined empirically. Means for adjusting the stringency of a binding reaction are well-known to those of skill in the art.

The term “subject” refers to human and non-human animals (especially non-human mammals). In addition to human, it also encompasses other non-human animals such as cows, horses, sheep, pigs, cats, dogs, mice, rats, rabbits, guinea pigs, monkeys.

The term “target,” “target molecule,” or “target cell” refers to a molecule or biological cell of interest that is to be analyzed or detected, e.g., a nucleotide, an oligonucleotide, a polynucleotide, a polypeptide, a protein, or a blood cell.

A cell has been “transformed” by an exogenous or heterologous polynucleotide when such polynucleotide has been introduced inside the cell. The transforming DNA may or may not be integrated (covalently linked) into the genome of the cell. In prokaryotes, yeast, and mammalian cells for example, the transforming polynucleotide may be maintained on an episomal element such as a plasmid. With respect to eukaryotic cells, a stably transformed cell is one in which the transforming polynucleotide has become integrated into a chromosome so that it is inherited by daughter cells through chromosome replication. This stability is demonstrated by the ability of the eukaryotic cell to establish cell lines or clones comprised of a population of daughter cells containing the transforming polynucleotide. A “clone” is a population of cells derived from a single cell or common ancestor by mitosis. A “cell line” is a clone of a primary cell that is capable of stable growth in vitro for many generations.

A “vector” is a replicon, such as plasmid, phage or cosmid, to which another polynucleotide segment may be attached so as to bring about the replication of the attached segment. Vectors capable of directing the expression of genes encoding for one or more polypeptides are referred to as “expression vectors”.

### II. Overview and General Rationale

The present invention is predicated in part on the pioneering work of the present inventors in simultaneously selecting multiple cognate binding partners (e.g., antigen-antibody) by selection of a library of one binding pair member (e.g., antibodies) against a library of the other binding pair member (e.g., antigens). As detailed in the Examples below, this process is enabled by using two different display platforms for the two binding partners (e.g., antibodies and antigens). In accordance with the present invention, these two platforms allow the specific interactions of the binding members with minimal background interaction of the platforms themselves. In addition, the phenotype-genotype link, i.e., link between the binding properties of a binding member (e.g., specificity of an antibody or antigenicity of an antigen) and the corresponding coding polynucleotide sequence of the binding member, is maintained in each platform. The link between the two platforms (i.e., the specific interactions between the cognate binding partners) is also maintained throughout the selection process in order to identify the cognate antibody-antigen binding pairs. This is followed by subjecting the binding partners to disruption of the interaction, amplification of the binders, and further studies (e.g., sequence analysis).

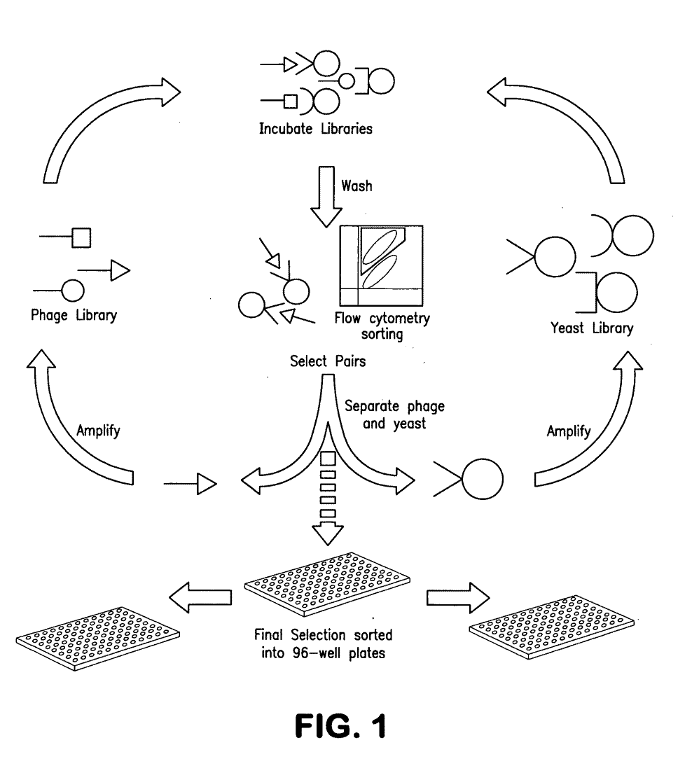

An exemplary scheme showing the strategy for the library-against-library selection and screening is illustrated in FIG. 1. As demonstrated in the Examples below, the inventors successfully identified an antibody-antigen binding pair upon mixing a yeast displayed antibody library and a phage displayed antigen library. In one study (see Examples 4 and 5), the cognate antibody and antigen were each present in the respective library at a frequency of 1:10⁴, which makes the frequency of the cognate pair 1:10⁸ when the libraries are mixed.

In accordance with these studies, the present invention provides methods for simultaneously identifying one or more cognate binding partners from two libraries of candidate biomolecules. Compositions (e.g., screening systems or kits) for carrying out such methods are also provided. Typically, each library will have a plurality of diverse members in the amount of at least 10, 25, 50, 10², preferably at least 10³, more preferably at least 10⁴, 10⁵, 10⁶, 10⁷, 10⁸ or more. To facilitate interactions between cognate binding partners and subsequent amplification and identification, the two libraries of candidate biomolecules are each provided in a surface displayed platform. After being expressed on the surface display platforms, members of the two libraries are put into contact under conditions that are conducive to formation of specific interactions between the biomolecules of the two libraries. Typically, the display platforms to be employed in the present invention are replicable genetic packages (e.g., cells, spores or viruses) or biological systems such as cell membrane, cell wall, or cellular appendages such as, for example, flagella, cilia, fimbria, or pilli. In some embodiments, the invention may also employ non-biological display platforms. For example, candidate biomolecules (polypeptides) can be attached to a non-nucleic acid tag that identifies the biomolecules. Such a tag can be a chemical tag attached to a bead that displays the biomolecule or a radiofrequency tag (see, e.g., U.S. Pat. No. 5,874,214). However, the preferred embodiments of the invention employ biological display platforms as opposed to non-biological physical media (such as miorotiter plates, glass slides or beads) as the display media.

In various embodiments, the two display platforms employed in the screening are not identical. Thus, in these embodiments, the two display platforms are not derived from the same type of biological system (e.g., not both being cell based display platforms or both being phage based platforms) or the same species of a given biological system (e.g., not being the same cell based platform or the same phage based platform). Usually, the candidate biomolecules are linked to or associated with the surface of the replicable package via a non-natural linkage (e.g., by recombinant fusion expression). Preferably, the biomolecules are polypeptides, peptides, or proteins. Typically, polynucleotides encoding such candidate biomolecules are expressed as polypeptides (with or without spacer or framework residues) fused to all or part of an outer surface protein of the replicable package. Often, the polynucleotides to be expressed on the surface of the replicable package (e.g., a cell or a phage) are exogenous to the replicable genetic package.

In some preferred embodiments, one of the two libraries of candidate biomolecules is displayed on a non-cell based display platform or replicable genetic package system (e.g., bacteriophage or eukaryotic viruses). Preferred systems are filamentous phage, and most preferably M13, fd, fl, or engineered variants thereof. The other library of candidate biomolecules is displayed on a cell based display platform or replicable genetic package (e.g., yeast cells). Members (e.g., bacteriophage population) displaying the first library of candidate biomolecules are then put into contact with cells (e.g., yeast cells) displaying the second library of candidate biomolecules under conditions that enable optimal receptor-ligand interactions (e.g., antibody-antigen binding). Cells with bound members of the first library are then separated from free members of the two libraries. These cells can be further subject to additional selection, e.g., disruption of the interaction, additional amplification and propagation, and subsequent studies (e.g., sequencing analysis of each of the two cognate binders).

Cognate binding partners or binding pairs can be identified in various libraries of candidate biomolecules. The type of interaction between members of the two libraries is not particularly limited so long as binding can be achieved, e.g., electrostatic, ionic, hydrophobic, van der waals, covalent, adhesion, and the like. Preferably, biomolecules of the two cognate libraries are those which can be produced by cellular expression processes, e.g., peptides, oligopeptides, polypeptides or proteins. Thus, biomolecules from which binding partners are to be identified can be polypeptides, including but not limited to random combinatorial amino acid libraries, polypeptides encoded by randomly fragmented chromosomal DNA, polypeptides encoded by cDNA pools, polypeptides encoded by EST libraries, antibody binding domains or fragments, receptor ligands, and enzymes. Such polypeptides may be displayed as single chains or as multichain complexes on the display platforms described herein. In some preferred embodiments, the methods of the invention are directed to identifying binding partners between two libraries of candidate polypeptides or between a library of candidate polypeptides and a library of short peptides. For example, one library can comprise antibodies or antigen-binding fragments as described above (e.g., scFv, dAb, Fab or F(ab′)₂), and the other library contain polypeptide antigens or antigenic fragments.

The two libraries of candidate polypeptides to be screened with methods of the present invention can also be other proteins and interacting partners (e.g., peptides or polypeptides) other than cognate antibody-antigen libraries. Various other proteins and cDNA libraries have been displayed on phage or cell based display platforms (e.g., yeast cells), including enzymes, protease and other enzyme inhibitors, Fc-receptor fragments, protein A and L, cytokines, hormones, toxins, and DNA-binding domains. These proteins were used to analyze and improve inhibitory activities, to study protein-protein or protein-DNA interactions, and to improve protein folding. cDNA libraries have also been constructed by either fusing the cDNA directly to phage gene III or by linking it through heterodimerization between a N-terminal leucine-zipper motif fused to the cDNA and a dimerization partner fused to gene III. cDNA libraries have been used to isolate interacting proteins by selection with a target protein.

When the two libraries (e.g., a library of antibodies and a library of antigens) are screened for binding partners, the members in each library can be structurally or functionally related or unrelated. For example, the antibody library can comprise unrelated antibodies from a naïve antibody library. Alternatively, the antibody library can comprise antibodies which are derived from a specific antibody, e.g., by DNA shuffling or mutagenesis. Similarly, an antigen library can encompass all proteins encoded by a cDNA library from a specific cell (e.g., a tumor cell or a bone marrow cell) of either a healthy or diseased tissue (e.g., a tumor tissue). Such a library contains many different targets of therapeutic interest. The antigen library can also be prepared from one specific antigen, e.g., antigenic fragments of a specific polypeptide or randomly mutagenized derivatives of a polypeptide. Typically, diversity of the libraries employed in the present invention is not limited to any size but in general, each library comprises at least more than 10, 25, 50, 10², 10³, 10⁴, 10⁵, 10⁶, 10⁷, or 10⁸ members.

Biomolecules for constructing the cognate libraries for practicing the present invention can be readily obtained in accordance with knowledge well known in the art. For example, antigen-expressing cDNA libraries can be obtained from any cell from a prokaryotic or eukaryotic organism. The eukaryotic organism is preferably a fungus, a plant or an animal organism, preferably a mammal. In some preferred embodiments, the cell is from a mammal such as a mouse, a rat or a human (e.g., a bone marrow cell). In some methods, the cDNAs are isolated from a differentiated tissue or a differentiated cell population. For example, the cDNAs can be isolated from any tissue or organ of a mammal, e.g., liver, brain, lung, heart, prostate, breast, colon as well as other cardiovascular, respiratory, gastrointestinal tissues. The cells from which cDNAs are isolated can be either a healthy tissue or a diseased tissue. In the latter case, the tissue or cells can be obtained from, e.g., a subject with tumor in the specific tissue, with hypertrophy or inflammation.

cDNAs from the various cells or tissues can be isolated with routinely practiced methods and techniques. For example, cDNA libraries of human bone marrow cells can be generated as described in Derubeis et al., Gene 255:195-203, 2000; and Kuznetsov et al., J. Bone Miner. Res. 12:1335-1347, 1997. Preparation of a cDNA library from a tumor cell (e.g., colorectal cancer cell) as well as phage display of such library is described in Somers et al., J. Immunol. 169:2772-80, 2002. Other relevant disclosures are also provided in the art. For example, Shu et al. (Cell Mol. Immunol. 3:53-7, 2006) described construction of a cDNA library from nasopharyngeal carcinoma. Munguia et al. (Neurosci Lett. 397:79-82, 2006) described construction and screening of a human brain cDNA library. Bidlingmaier and Liu (Mol. Cell. Proteomics. 5:533-40, 2006) described the construction and application of a yeast surface-displayed human testis cDNA library. Many other types of antigen-encoding cDNA libraries are also known in the art.

Various known libraries of antibodies can also be utilized in the present invention. For example, libraries of naïve antibodies (e.g., scFv libraries from human spleen cells) can be prepared as described in Feldhaus et al., Nat. Biotechnol. 21:163-170, 2003; and Lee et al., Biochem. Biophys. Res. Commun. 346:896-903, 2006. Park et al. (Antiviral Res. 68:109-15, 2005) also described a large nonimmunized human phage antibody library in single-chain variable region fragment (scFv) format. Antibody library derived from a subject with a specific disease (e.g., a microbial infection) can be prepared from RNA extracted from peripheral blood lymphocytes of the subject, using methods as described in Kausmally et al. (J. Gen. Virol. 85:3493-500, 2004). In addition, libraries of synthetic antibodies can also be employed in the practice of the present invention. For example, Griffiths et al. (EMBO J. 13:3245-3260, 1994) described a library of human antibodies generated from large synthetic repertoires (lox library). Further, some embodiments of the invention employ libraries of antibodies that are derived from a specific scaffold antibody. Such antibody libraries can be produced by recombinant manipulation of the reference antibody using methods described herein or otherwise well known in the art. For example, Persson et al. (J. Mol. Biol. 357:607-20, 2006) described the construction of a focused antibody library for improved hapten recognition based on a known hapten-specific scFv.

Many techniques well known in the art can be readily employed to increase the diversity of the members of a library of biomolecules. These include, e.g., combinatorial chain shuffling, humanization of antibody sequences, introduction of mutations, affinity maturation, use of mutator host cells, etc. These methods can all be employed in the practice of the methods described herein at the discretion of the artisan. See, e.g., Aujame et al., Hum. Antibod. 8: 155-168, 1997; Barbas et al., Proc. Natl. Acad. Sci. USA 88: 7978-82, 1991; Barbas et al., Proc. Natl. Acad. Sci. USA 91: 3809-13, 1994; Boder et al., Proc. Natl. Acad. Sci. USA 97: 10701-10705, 2000; Crameri et al., Nat. Med. 2: 100-102, 1996; Fisch et al., Proc. Natl. Acad. Sci. USA 93: 7761-7766, 1996; Glaser et al., J. Immunol. 149: 3903-3913, 1992; Eying et al., Immunotechnology, 2: 127-143, 1996; Kanppik et al., J. Mol. Biol., 296: 57-86, 2000; Low et al., J. Mol. Biol. 260: 359-368, 1996; Riechmann and Winter, Proc. Natl. Acad. Sci. USA, 97: 10068-10073, 2000; and Yang et al., J. Mol. Biol. 254: 392-403, 1995.

In some preferred embodiments of the invention, one of the two libraries used is a library of antibodies. Antibody libraries can be single or double chain. In some of the embodiments, a single chain antibody display library is used. Single chain antibody libraries can comprise the heavy or light chain of an antibody alone or the variable domain thereof. However, more typically, the members of single-chain antibody libraries are formed from a fusion of heavy and light chain variable domains separated by a peptide spacer within a single contiguous protein. See e.g., Ladner et al., WO 88/06630; McCafferty et al., WO 92/01047. While expressed as a single protein, such single-chain antibody constructs can actually display on the surface of bacteriophage as double-chain or multi-chain proteins. See, e.g., Griffiths et al., EMBO J. 12: 725-34, 1993. Alternatively, double-chain antibodies may be formed by noncovalent association of heavy and light chains or binding fragments thereof. The diversity of antibody libraries can arise from obtaining antibody-encoding sequences from a natural source, such as a nonclonal population of immunized or unimmunized B cells. Alternatively, or additionally, diversity can be introduced by artificial mutagenesis as discussed herein for other proteins.

In some embodiments, double-chain or multi-chain antibodies display libraries can be employed. Production of such libraries is described by, e.g., Dower, U.S. Pat. No. 5,427,908; Huse WO 92/06204; Huse, in Antibody Engineering, (Freeman 1992), Ch. 5; Kang, WO 92/18619; Winter, WO 92/20791; McCafferty, WO 92/01047; Hoogenboom, WO 93/06213; Winter et al., Anile. Rev. Immunol. 12: 433-455, 1994; Hoogenboom et al., Immunol. Rev. 130: 41-68, 1992; and Soderlind et al., Immunol. Rev 130: 109-124, 1992. In double-chain antibody libraries for example, one antibody chain is fused to a package surface protein (e.g., a phage coat protein), as is the case in single chain libraries. The partner antibody chain is complexed with the first antibody chain, but the partner is not directly linked to a package surface protein. Either the heavy or light chain can be the chain fused to the package surface protein. Whichever chain is not fused to the coat protein is the partner chain. This arrangement is typically achieved by incorporating nucleic acid segments encoding one antibody chain gene into, e.g., either gIII or gVIII of a phage display vector to form a fusion protein comprising a signal sequence, an antibody chain, and a phage coat protein. Nucleic acid segments encoding the partner antibody chain can be inserted into the same vector as those encoding the first antibody chain. Optionally, heavy and light chains can be inserted into the same display vector linked to the same promoter and transcribed as a polycistronic message. Alternatively, nucleic acids encoding the partner antibody chain can be inserted into a separate vector (which may or may not be a phage vector). In this case, the two vectors are expressed in the same cell (see, e.g., WO 92/20791). The sequences encoding the partner chain are inserted such that the partner chain is linked to a signal sequence, but is not fused to the package surface protein (e.g., a phage coat protein). Both antibody chains are expressed and exported to the periplasm of the cell where they assemble and, with phage display platform, are incorporated into phage particles.

In some embodiments, one of the libraries of candidate biomolecules comprises variants or mutants derived from a single candidate polypeptide or a starting framework protein (e.g., a target molecule). For example, a polynucleotide molecule encoding the candidate protein may be altered at one or more selected codons. An alteration is defined as a substitution, deletion, or insertion of one or more nucleotides in the gene encoding the candidate protein that results in a change in the amino acid sequence of the polypeptide. Preferably, the alterations will be by substitution of at least one amino acid with any other amino acid in one or more regions of the molecule. The alterations may be produced by a variety of methods known in the art. These methods include, but are not limited to, oligonucleotide-mediated mutagenesis (e.g., Zoller et al., Methods Enzymol. 154:329-50, 1987), cassette mutagenesis (e.g., Well et al. Gene 34:315, 1985), error-prone PCR (see, e.g., Saiki et al., Proc. Natl. Acad. Sci. USA. 86:6230-4, 1989; and Keohavong and Thilly, Proc. Natl. Acad. Sci. USA., 86:9253-7, 1989), and DNA shuffling (Stemmer, Nature 370:389-91, 1994; and Stemmer, Proc. Natl. Acad. Sci. 91:10747-51, 1994).

Once expressed in the respective display platforms, the two libraries of candidate biomolecules can be then used directly in subsequent library-library screening. However, depending on the specific libraries to be screened, each library may be subject to centain enrichment or panning steps prior to the library-library screening. For example, a library of antibodies to be screened against a library of polypeptide fragments of a specific antigen may need to be enriched for recognition of the antigen or desired affinity. Similarly, the cognate library of polypeptide antigen fragments can be enriched for antigenicity. Methods for enriching displayed libraries are well known in the art (e.g., Parmley and Smith, Gene 73: 305-318, 1988) and also exemplified herein. In addition, library members can also be subject to amplification before performing the library-library screening. For example, a phage library members (e.g., antibodies) enriched on an immobilized target (e.g., an antigen bound to beads) can be amplified by immersing the beads in a culture of host cells (e.g., E. coli. cells). Likewise, cell based display libraries can be amplified by adding growth media to bound library members.

The following sections provide more detailed guidance for practicing the present invention.

### III. Expression of Candidate Biomolecules on Non-cell Based Display Platforms

In order to simultaneously identify multiple binding partners in two cognate libraries of candidate polypeptides or peptides, two display platforms are employed. In some preferred embodiments of the invention, one of the two libraries of candidate biomolecules (“the first library of candidate biomolecules”) is expressed in a non-cell based surface display platform (e.g., bacteriophage or eukaryotic viruses), and the other library of candidate biomolecules (“the second library of candidate biomolecules”) is expressed in a cell based surface display platform, e.g., yeast cell.

Any non-cell based display platform or replicable genetic package system can be used to display one of the two libraries of candidate polypeptides in the present invention. For example, eukaryotic virus display of human heregulin fused to gp70 of Moloney murine leukemia virus has been reported by Han et al., Proc. Natl. Acad. Sci. USA 92: 9747-9751, 1995. Spores can also be used as replicable genetic packages. In this case, polypeptides are displayed from the outersurface of the spore. For example, spores from B. subtilis have been reported to be suitable. Sequences of coat proteins of these spores are provided in Donovan et al., J. Mol. Biol. 196: 1-10, 1987. In addition, a ribosome based display platform may also be used in some embodiments of the invention. In these embodiments, RNA and the polypeptide encoded by the RNA can be physically associated by stabilizing ribosomes that are translating the RNA and have the nascent polypeptide still attached. See, e.g., Mattheakis et al., Proc. Natl. Acad. Sci. USA 91:9022, 1994; Hanes et al., Nat. Biotechnol. 18:1287-92, 2000; Hanes et al., Methods Enzymol. 328:404-30, 2000; and Schaffitzel et al., J. Immunol. Methods. 231:119-35, 1999.

Bacterial phages are the preferred systems for expressing one of two libraries of candidate biomolecules in the practice of the present invention. As first described for the display of EcoRI endonuclease (Smith et al, Science 228: 1315-17, 1985), the principle underlying all phage display platforms is the physical linkage of a polypeptide's phenotype to its corresponding genotype. In practice, the proteins or peptides to be displayed are usually expressed as fusions with the phage coat protein pIII or pVIII (or other coat proteins as described in Sidhu, Biomol. Eng. 18:57-63, 2001). Such fusion proteins are directed to the bacterial periplasm or inner cell membrane by an appropriate signal sequence that is added to their N terminus. During the phage assembly process the fusion proteins are incorporated into the nascent phage particle. The genetic information encoding the displayed fusion protein is packaged inside the same phage particle in the form of a single-stranded DNA (ssDNA) molecule. Hence, the genotype-phenotype coupling occurs before the phages are released into the extracellular environment, ensuring that phages produced from the same bacteria cell clone are identical.

With phage display, huge display libraries containing up to 10¹⁰ individual members can be created from batch-cloned gene libraries. Most applications of phage display libraries aim at identifying polypeptides that bind to a given target molecule. The enrichment of phages that present a binding protein (or peptide) is achieved by affinity selection of a phage library on the immobilized target. In this “panning” process, binding phages are captured whereas nonbinding ones are washed off. In the next steep, the bond phages are eluted and amplified by reinfection of E. coli cells. The amplified phage population can, in turn, be subjected to the next round of panning. See, e.g., WO 91/19818; WO 91/18989; WO 92/01047; WO 92/06204; WO 92/18619; Han et al., Proc. Natl. Acad. Sci. USA 92: 9747-51, 1995; Donovan et al., J. Mol. Biol. 196: 1-10, 1987.

While other phages can also be used (e.g., lambda, T-even phage such as T4, T-odd phage such as T7, etc.), phage display in the present invention preferably employs E. coli filamentous phage such as M13, fd, fl, and engineered variants thereof. An example of engineered variants of these phages is fd-tet, which has a 2775-bp BglII fragment of transposon Tn10 inserted into the BamHI site of wild-type phage fd. Because of its Tn10 insert, fd-tet confers tetracycline resistance on the host and can be propagated like a plasmid independently of phage function as the displaying replicable genetic package. Using M13 as an exemplary filamentous phage, the phage virion consists of a stretched-out loop of single-stranded DNA (ssDNA) sheathed in a tube composed of several thousand copies of the major coat protein pVIII (product of gene VIII or “gVIII”). Four minor coat proteins are found at the tips of the virion, each present in about 4-5 copies/virion: pIII (product of gene III or “gIII”), pIV (product of gene IV or “gIV”), pVII (product of gene VII or “gVII”), and pIX (product of gene IX or “gIX”). Of these, pIII and pVIII (either full length or partial length) represent the most typical fusion protein partners for polypeptides of interest. A wide range of polypeptides, including random combinatorial amino acid libraries, randomly fragmented chromosomal DNA, cDNA pools, antibody binding domains, receptor ligands, etc., may be expressed as fusion proteins, e.g., with pIII or pVIII, for selection in phage display methods. In addition, methods for the display of multichain proteins (where one of the chains is expressed as a fusion protein) are also well known in the art.

Phage system has been employed successfully for the display of functional proteins such as antibody fragments (scFv or Fab′), hormones, enzymes, and enzyme inhibitors, as well as the selection of specific phage on the basis of functional interactions (antibody-antigen; hormone-hormone receptor; enzyme-enzyme inhibitor). See, e.g., Paschke, Appl. Micbiol. Biotechnol. 70:2-11, 2006; and Kehoe and Kay, Chem. Rev. 105:4056-72, 2005. In general, phage display platforms can be grouped into two classes on the basis of the vector system used for the production of phages. True phage vectors are directly derived from the genome of filamentous phage (M13, fl, or fd) and encode all the proteins needed for the replication and assembly of the filamentous phage (Cwirla et al., Proc. Natl. Acad. Sci. USA 87:6378-6382, 1990; Scott and Smith, Science 249:386-390, 1990; Petrenko et al., Protein. Eng. 9:797-801, 1996; and McLafferty et al., Gene 128:29-36, 1993). In these vectors, the library is ether cloned as a fusion with the coat protein originally present in the phage genome or inserted as fusion gene cassette with an additional copy of the coat protein. The former vector system produces phages exclusively presenting the fusion coat protein, whereas the latter system yields phages that present the wild type and the fusion coat protein on the same phage particle.

The second group of phage display platforms utilizes phagemid vectors (see, e.g., Marks et al., J. Mol. Biol. 222:581-597, 1991; and Barbas et al., Proc. Natl. Acad. Sci. USA 88:7978-7982, 1991) which produce the fusion coat protein. A phagemid is a plasmid that bears a phage-derived origin of replication in addition to its plasmid origin of replication. The phage-derived origin of replication is also known as intergenic region. Besides its function in DNA replication, the intergenic region contains a 78-nucleotide hairpin section (packaging signal), which promotes the packaging of the ssDNA in the phage coat. However, the production of phages containing the phagemid genome can only be achieved when additional phage derived proteins are present. For the purpose of phage display, these proteins are simply provided by superinfecting phagemid-carrying cells with a helper phage. In this procedure, often called “phage rescue,” the helper phage provides all the proteins and enzymes required for phagemid replication, ssDNA production and packaging, and also the structural proteins forming the phage coat. The replication and packaging machinery supplied by the helper phage acts on the phagemid DNA and on the helper phage genome itself. Therefore, two distinct types of phage particles with different genotypes are produced from cells bearing phagemid and helper phage DNA: (1) those carrying the phagemid genome and (2) those carrying the helper phage genome. Phage particles containing the helper phage genome are useless in phage display processes even if they present the desired phenotype because they do not contain the required genetic information. The fraction of phages containing helper phage genome can be reduced to ˜1/1,000 by using a helper phage with a defective origin of replication or packaging signal, which leads to preferential packaging of the phagemid DNA over the helper phage genome. Independent of the genotype, phagemid-based display platforms usually yield phages with a hybrid phenotype displaying wild type and fusion coat protein on the same particle.

Detailed procedures for using phage display platforms are provided in the art. See, e.g., Barbas et al., Phage Display: A Laboratory Manual, Cold Spring Harbor Laboratory Press (2001); and Bowley et al., Protein Eng. Des. Sel. 20:81-90, 2007. Only routinely practiced standard recombinant DNA techniques are required to express a library of candidate polypeptides in a phage display platform in the practice of the present invention, as demonstrated in the Examples below. Such techniques are described, e.g., in Sambrook et al., Molecular Cloning: A Laboratory Manual, Cold Spring Harbor Press, N.Y., (3^{rd} ed., 2000); and Brent et al., Current Protocols in Molecular Biology, John Wiley & Sons, Inc. (ringbou ed., 2003). Fusion of the candidate polynucleotide and the phage polynucleotide can be accomplished by inserting the phage polynucleotide into a particular site on a plasmid that also contains the candidate polynucleotide gene, or by inserting the candidate polynucleotide into a particular site on a plasmid that also contains the phage polynucleotide. The fusion polypeptides typically comprise a signal sequence, usually from a secreted protein other than the phage coat protein, a polypeptide to be displayed and either the gene III or gene VIII protein or a fragment thereof effective to display the polypeptide. The gene III or gene VIII protein used for display is preferably from (i.e., homologous to) the phage type selected as the display vehicle. Exogenous coding sequences are often inserted at or near the N-terminus of gene III or gene VIII although other insertion sites are possible.

Either a phage system or a phagemid system can be used to display the candidate polypeptides or peptides in the practice of the present invention. In some preferred embodiments, vectors for expressing candidate library of proteins in phage display are M13 phage vectors. Examples of such vectors include, but are not limited to, fUSE5, fAFF1, fd-CAT1, m663, 33, 88, Phagemid, pHEN1, pComb3, pComb8, plantar 5E, p8V5, and ASurfZap. Some filamentous phage vectors have been engineered to produce a second copy of either gene III or gene VIII. In such vectors, exogenous sequences are inserted into only one of the two copies. Expression of the other copy effectively dilutes the proportion of fusion protein incorporated into phage particles and can be advantageous in reducing selection against polypeptides deleterious to phage growth. In another variation, exogenous polypeptide sequences are cloned into phagemid vectors which encode a phage coat protein and phage packaging sequences but which are not capable of replication. Phagemids are transfected into cells and packaged by infection with helper phage. Use of phagemid system also has the effect of diluting fusion proteins formed from coat protein and displayed polypeptide with wildtype copies of coat protein expressed from the helper phage. See, e.g., Garrard, WO 92/09690.

The choice of expression vector depends on the intended host cells in which the vector is to be expressed. Typically, the vector includes a promoter and other regulatory sequences in operable linkage to the inserted coding sequences that ensure the expression of the latter. Use of an inducible promoter is advantageous to prevent expression of inserted sequences except under inducing conditions. Examples of inducible promoters include arabinose promoter, metallothionein promoter or heat shock promoters. Cultures of transformed organisms can be expanded under noninducing conditions without biasing the population for coding sequences whose expression products are better tolerated by the host cells. The vector may also provide a secretion signal sequence positioned to form a fusion protein with polypeptides encoded by inserted sequences, although often inserted polypeptides are linked to a signal sequences before inclusion in the vector. Vectors to be used to receive sequences encoding antibody light and heavy chain variable domains sometimes encode constant regions or parts thereof that can be expressed as fusion proteins with inserted chains thereby leading to production of intact antibodies or fragments thereof.

In some embodiments, the sequences to be displayed on the surface of phage particles can comprise amino acids encoding one or more tag sequences. Such tag sequences can facilitate identification and/or purification of fusion proteins. Such tag sequences include, but are not limited to, glutathione S transferase (GST), maltose binding protein (MBP), thioredoxin (Tax), calmodulin binding peptide (CBP), poly-His, FLAG, c-myc, and hemagglutinin (HA). GST, MBP, Trx, CBP, and poly-His enable purification of their cognate fusion proteins on immobilized glutathione, maltose, phenylarsine oxide, calmodulin, and metal-chelate resins, respectively. FLAG, c-myc, and hemagglutinin (HA) enable immunoaffinity purification of fusion proteins using commercially available monoclonal and polyclonal antibodies that specifically recognize these epitope tags. Other suitable tag sequences will be apparent to those of skill in the art.

The vector with inserted exogenous gene can be transformed into a suitable host cell. Prokaryotes are the preferred host cells for phage vectors. Suitable prokaryotic host cells include, e.g., E coli strain JM109, E coli strain JM101, E. coli K₁₂ strain 294 (ATCC number 31,466), E. coli strain W3110 (ATCC number 27,325), E. coli strain X1776 (ATCC number 31,537), and E. coli XL1-Blue cells (Stratagene, La Jolla, Calif.). However, many other strains of E. coli, such as HB101, NM522, NM538, NM539, and cells from many other species and genera of prokaryotes can also be used. For example, bacilli such as Bacillus subtilis, other enterobacteriaceae such as Salmonella trphimurium or Serratia marcesans, and various Pseudomonas species may all be used as hosts.

Transformation of prokaryotic cells can be readily accomplished using methods well known in the art, e.g., Sambrook et al., supra; and Brent et al., supra. For example, the calcium chloride method is a suitable method for transforming a prokaryotic host cell with a phage display vector. Alternatively, electroporation (Neumann et al., EMBO J., 1:84, 1982) may be used to transform these cells. The transformed cells are selected by growth on an antibiotic, e.g., tetracycline (tet) or ampicillin (amp), to which they are rendered resistant due to the presence of tet and/or amp resistance genes on the vector.

As noted above, various types of candidate biomolecules can be expressed in a phage display platform. In some preferred embodiments of the invention, a library of candidate antibodies are expressed in a phage display platform. Antibodies have been displayed on phage in form of scFv or Fab′ fragments using either the phage or the phagemid system. For example, in the latter case, either the V_{H}-C_{H1} or V_{L}-C_{L} chain is fused to gene III or gene VIII while the other chain is expressed without fusion. As described above, a number of strategies can be used to generate combinatorial antibody libraries. For example, the initial libraries can be produced from spleen cells of an immunized subject (immune library). In this case, like the hybridoma technology, immunization is necessary for each antigen. The initial antibody libraries can also be generated from synthetic antibodies.

In some preferred embodiments, antibody libraries are generated from B lymphocytes of unimmunized donors (naïve libraries). Antibodies against virtually any antigen can be directly isolated from such a ‘single pot’ library, thus bypassing immunization. Furthermore, using B lymphocytes from various organs of human donors (e.g. PBLs, spleen, tonsils, bone marrow) for construction of antibody libraries, the isolated antibody fragments will be entirely human which is of special interest for therapeutic applications. In a third approach, the germline V genes can be used as starting material to generate semi-synthetic libraries. Since the V genes are missing the region coding for CDR3 and framework 4, this part of the V_{H} and V_{L} domains is added by PCR introducing random codons at the CDR3 positions. Using large repertoires of naïve and semi-synthetic libraries, it was shown that high-affinity antibodies can be isolated against foreign as well as self antigens, comparable in affinity to those of a secondary immune response. Using phage display technology it is possible to further increase the affinity of a primary isolate by mutagenesis, chain shuffling or CDR walking and re-selection on the antigen (affinity maturation).

In some other embodiments, a library of candidate peptides is expressed in a phage display platform (see, e.g., Cwirla et al., Proc. Natl. Acad. Sci. USA. 87:6378-82, 1990). Peptide libraries can be used for a variety of different studies, including epitope mapping, analysis of protein-protein interaction and the isolation of inhibitors, antagonists, and agonists. Since peptides normally exhibit a rather low affinity for their target sequence, the phage system can be used for multivalent display of the peptides. These peptides are either displayed in an unconstraint form or in a constraint form by introducing flanking cysteine residues. The latter peptides are much less flexible and peptides selected from constrained libraries have quite often higher affinities as those selected from unconstrained libraries. Various peptide libraries with random sequences up to 38 amino acids have been generated in the art. However, since the number of possible permutations increases exponentially with each random amino acid added, the size of the library is a limiting factor. Six random amino acids produce a diversity of 6.4×10⁷ possible sequences, while 12 random amino acids generate a diversity of 4×10¹⁵. The size of a library is limited by the efficiency of transformation and the sizes of libraries generated normally possess a diversity of 10⁸-10⁹ different clones. Thus, libraries of peptides longer than seven amino acids represent only a fraction of all possible sequences. However, libraries of peptides longer than 10 amino acids have been successfully used for the isolation of specific ligands.

In some other embodiments, the first library of candidate biomolecules to be expressed in a phage display platform relate to other proteins or cDNA libraries. These include enzymes, protease and other enzyme inhibitors, Fc-receptor fragments, protein A and L, cytokines, hormones, toxins, and DNA-binding domains. cDNA libraries encoding such proteins can be constructed, e.g., by fusing the cDNA directly to gene III of a phage or by linking it through heterodimerization between a N-terminal leucine-zipper motif fused to the cDNA and a dimerization partner fused to gene III.

Phage particles displaying a library of candidate biomolecules (e.g., polypeptides or peptides) can be produced by culturing host cells that have been transformed with the recombinant phagemid or phage vectors, in accordance with the procedures described herein or that is well known in the art. For example, host cells (e.g., XL1-Blue E. coli cells) harboring vectors encoding the fusion polypeptides can be grown under suitable conditions (e.g., at 37° C. in superbroth-medium containing 1% glucose and appropriate antibiotics) to allow propagation of phage particles. If needed, a helper phage is also added. The phage particles released into the growth medium (cell supernatant) can be then harvested in the form of phage medium at that time. The harvested phage particles can be then used directly in subsequent screening. The phage particles can also be precipitated (e.g., by centrifugation) and resuspended in a different solution (e.g., PBS, pH 7.4) for the subsequent screening.

Alternatively, the harvested phage particles are first enriched before being used in subsequent screening. As described herein, this is typically achieved by affinity selection or panning, using a target compound (e.g., an antigen) to which the displayed molecules (e.g., antibodies) are intended to bind. If desired, several rounds of enrichment procedures can be carried out, e.g., under conditions with increasingly higher stringency. Following enrichment, the enriched phage library of candidate biomolecules can again be propagated and amplified in host cells. For subsequent selection against a cognate library of candidate biomolecules, the enriched and amplified phage particles are usually harvested from the culture medium and resuspended in appropriate solutions. Detailed procedures for carrying out each of these steps are well known in the art. See, e.g., Barbas et al., Phage Display: A Laboratory Manual, Cold Spring Harbor Laboratory Press (2001); and Bowley et al., Protein Eng. Des. Sel. 20:81-90, 2007. Exemplified conditions and procedures for enrichment, propagation and harvest of phage display particles are also provided in the Examples below.

### IV. Expression of Candidate Biomolecules with Cell Based Display Platforms

To practice the present invention, the libraries of candidate biomolecules (e.g., polypeptides or peptides) can also be expressed via cell based surface display platforms or replicable genetic packages. Cell based systems for displaying combinatorial libraries are well known in the art (see, e.g., U.S. Pat. No. 6,214,613 to K. Higuchi et al. “Expression Screening Vector”). With cell based systems, polypeptides to be displayed are inserted into a gene encoding a cellular protein that is expressed on the cell surface (package surface protein). As with non-cell based replicable genetic package systems, this allows one to circumvent separate expression, purification, and immobilization of binding proteins and enzymes. As noted above, some preferred embodiments of the invention employ one library of candidate biomolecules that are expressed in a non-cell based display platform (e.g., phage), and the second library of candidate biomolecules are expressed in a cell based surface display platform. Members of the two libraries are then put into contact (e.g., in solutions) in order to identify binding partners from the two cognate libraries of candidate biomolecules.

Several cell based surface display platforms well known in the art can be employed in the present invention. These include, e.g., prokaryotic cells such as E. coli, S. typhimurium, P. aeruginosa, B. subtilis, P. aeruginosa, V. cholerae, K pneumonia, N. gonorrhocae, N. meningitides, and etc. They also include eukaryotic cells such as yeast cells. Details of outer surface proteins (package surface proteins) for bacterial based display platforms are discussed in, e.g., U.S. Pat. No. 5,571,69S; Georgiou et al., Nat. Biotechnol. 15: 29-34, 1997 and references cited therein. For example, the lamB protein of E. coli is a suitable surface protein for displaying exogenous polypeptides. In other suitable E. coli based display platforms, an exogenous polypeptide or peptide library can be fused to the carboxyl terminus of the lac repressor and expressed in E. coli. A further E. coli based system allows display on the cell's outer membrane by fusion with a peptidoglycan-associated lipoprotein (PAL).

As exemplifications of prokaryotic based surface display, Wu et al. (FEMS Microbiol. Lett. 256:119-25, 2006) described cell surface display of Chi92 on Escherichia coli using ice nucleation protein. Kang et al. (FEMS Microbiol Lett. 226:347-53, 2003) similarly reported E. coli surface display for epitope mapping of hepatitis C virus core antigen. Cho et al. (Appl. Environ. Microbiol. 68:2026-30, 2002) described cell surface display of organophosphorus hydrolase in E. coli for selective screening of improved enzymatic activities. Other than E. coli, Lee et al. reported cell surface display of lipase in Pseudomonas putida KT2442 using OprF as an anchoring motif (Appl Environ Microbiol. 71:8581-6, 2005). Shimazu et al. (Biotechnol Prog. 19:1612-4, 2003) also described cell surface display of a protein (organophosphorus hydrolase) in Pseudomonas putida using an ice-nucleation protein anchor. In addition, Desvaux et al. (FEMS Microbiol Lett. 256:1-15, 2006) reviewed cell surface display of proteins in Gram-positive bacteria in general.

Other than prokaryotic cells, eukaryotic cell display libraries are also suitable for the practice of the present invention. Examples of eukaryotic cell display libraries include yeast (e.g., Saccharomyces cerevisiae, Schizosaccharomyces pombe, Hanseula, or Pichia pastoris), insect, plant, and mammalian libraries. The cells can be in a cell line or can be a primary culture cell type. For example, Riddle et al. described tumor cell surface display of immunoglobulin heavy chain Fc (Hum. Gene Ther. 16:830-44, 2005). Other display libraries based on mammalian cells are known in the art, e.g., U.S. Pat. No. 6,255,071; U.S. Pat. No. 6,207,371; U.S. Pat. No. 6,136,566; Holmes et al., J. Immunol. Methods, 1999, 230: 141-147; Chesnut et al. J. Immunol. Methods 193:17-27, 1996; and Chou et al., Biotechnol Bioeng. 65:160-169, 1999. However, as detailed below, yeast based display platforms are preferred in the practice of the present invention.

Yeast display has notable advantages if compared to some other display platforms such as phage display, ribosome display, bacterial display, and mRNA display. Yeast is an eukaryote, which means that sometimes proteins that can't be well folded in prokaryotes such as E. coli may fold well in yeast. Another important advantage of yeast display is that analysis of individual displayed polypeptide (e.g., scFv) clones on the surface of yeast is possible without having to purify proteins. Also, yeast is much larger than phage. Therefore, selection of a yeast display library selection can utilize various cytology techniques such as flow cytometry sorting. In the case of flow cytometry, one could visualize binding of yeast cells to a target during each selection round, unlike phage display where the outcome of binding is unknown until the output phage are amplified. In phage display, progress of the selection rounds is estimated from output titers (how many phage were selected) and by sampling clones from each round for binding. In addition, during phage display the stringency is altered by changing the concentration of blocking proteins (such as powdered milk proteins, or BSA) and detergents (such as Tween-20), and by increasing the number of washes to which the phage-polypeptide complex is subjected before elution of the bound phage.

In contrast, the use of flow cytometry in conjunction with a yeast display library overcomes some of the drawbacks seen with phage display. For example, using fluorescent-activated cell sorting (FACS), the stringency can be modulated by changing the concentration of antigen or blocking proteins in solution and the number of washes as for phage selections, but changes in stringency can also be made “on the fly” by setting the cell sort gate based on the antigen binding fluorescence. This flexibility allows rapid isolation of loss-of-binding populations, a task that is difficult to accomplish with phage display. Loss-of-binding sorting has been utilized to rapidly screen mutagenized proteins to identify binding residues. Yeast display selection with FACS has also been used to rapidly identify cross-reactive antibodies to two botulinum neurotoxin subtypes BoNT/A1 and BoNT/A2 by directly labeling the two antigens with different fluorophores and only selecting yeast cells that bind both.

Thus, in some preferred embodiments of the invention, one of the two cognate libraries of candidate biomolecules is expressed in a yeast display platform. Yeast display (or yeast surface display) is a well established system for protein engineering (Boder and Wittrup, Yeast surface display for screening combinatorial polypeptide libraries, Nat. Biotechnol. 15:553-7, 1997). Typically, a candidate polypeptide is expressed as a fusion to the Aga2p mating agglutinin protein, which is in turn linked by two disulfide bonds to the Agalp protein covalently linked to the cell wall. Expression of both the Aga2p-polypeptide fusion and Agalp are under the control of the galactose-inducible GAL1 promoter, which allows inducible overexpression. The expressed fusion polypeptides can also contain one or more peptide tags or epitope tags (e.g., c-myc and HA), allowing quantification of the library surface expression by, e.g., flow cytometry.

Yeast display has been employed in a number of successful applications, including engineering a high monovalent ligand-binding affinity for an engineered protein (Boder et al., Proc. Nat. Acad. Sci. 97:10701-10705, 2000). Many other successful applications of yeast display libraries have also been reported in the art. For example, Furukawa et al. (Biotechnol Prog. 22:994-7, 2006) described a yeast cell surface display platform for homo-oligomeric protein by coexpression of native and anchored subunits. Similarly, Shibasaki et al. reported development of combinatorial bioengineering using yeast cell surface display (Biosens. Bioelectron. 19:123-30, 2003). Nakamura et al. (Appl Microbiol Biotechnol. 57:500-5, 2001) described development of novel whole-cell immunoadsorbents by yeast surface display of the IgG-binding domain. Kim et al. (Yeast 19:1153-63, 2002) reported cell surface display platform using novel GPI-anchored proteins in yeast Hansenula polymorpha.

To practice the methods of the present invention, a library of candidate biomolecules (e.g., polypeptides) can be readily expressed in a yeast display platform. As described in the Examples below, procedures for constructing yeast surface displayed libraries of candidate biomolecules are well known in the art. For example, yeast surface displayed libraries of candidate polypeptides in the present invention can be generated in accordance with the teachings provided in many other prior art references, e.g., Bowley et al., Protein Eng. Des. Sel. 20:81-90, 2007; U.S. Pat. Nos. 6,300,065; 6,423,538; 6,300,065; and U.S. Patent Application 20040146976. Additional teachings of yeast display platforms are provided in many other prior art references. These include, e.g., Feldhaus et al., Nat. Biotechnol. 21:163-70, 2003 (Flow-cytometric isolation of human antibodies from a nonimmune Saccharomyces cerevisiae surface display library); Bhatia et al., Biotechnol Prog. 19:1033-1037, 2003 (Rolling Adhesion Kinematics of Yeast Engineered To Express Selectins); Yeung et al., Biotechnol Prog. 18:212-20, 2002 (Quantitative screening of yeast surface-displayed polypeptide libraries by magnetic bead capture); Wittrup, Curr. Opin. Biotechnol. 12:395-9, 2001 (Protein engineering by cell-surface display); Boder and Wittrup, Methods Enzymol. 328:430-44, 2000 (Yeast surface display for directed evolution of protein expression, affinity, and stability); Wittrup, Nat. Biotechnol., 18:1039-40, 2000 (The single cell as a microplate well); Boder et al., Proc. Natl. Acad. Sci. USA. 97:10701-5, 2000 (Directed evolution of antibody fragments with monovalent femtomolar antigen-binding affinity); Boder and Wittrup, Biotechnol Prog. 14:55-62, 1998 (Optimal screening of surface-displayed polypeptide libraries); Holler et al., Proc. Natl. Acad. Sci. USA. 97:5387-92, 2000 (In vitro evolution of a T cell receptor with high affinity for peptide/MHC); Bannister and Wittrup, Biotechnol Bioeng. 68:389-95, 2000 (Glutathione excretion in response to heterologous protein secretion in Saccharomyces cerevisiae); VanAntwerp and Wittrup, Biotechnol Prog. 16:31-7, 2000 (Fine affinity discrimination by yeast surface display and flow cytometry); Kieke et al., Proc. Natl. Acad. Sci. USA. 96:5651-6, 1999 (Selection of functional T cell receptor mutants from a yeast surface-display library); Shusta et al., Nat. Biotech. 16:773-7, 1998 (Increasing the secretory capacity of Saccharomyces cerevisiae for production of single-chain antibody fragments); Boder and Wittrup, Nat. Biotechnol. 15:553-7, 1997 (Yeast surface display for screening combinatorial polypeptide libraries); and Wittrup, Curr Opin Biotechnol. 6:203-8, 1995 (Disulfide bond formation and eukaryotic secretory productivity).

Typically, to generate a yeast surface displayed polypeptide library (e.g., scFv fragments) in the practice of the preset invention, a library of yeast shuttle plasmids are constructed. In this library, each plasmid containing a polynucleotide that encodes a member of the library of candidate biomolecules (e.g., a library of scFv fragments derived from a naïve antibody library or bone marrow cell cDNA library) can be fused to Aga2p. This can be derived from, e.g., the pCTCON vector by inserting the open reading frame of the scFv of interest between the NheI and BamHI sites (both of which should be in frame with the inserted sequence). The yeast strain used must have the Aga1 gene stably integrated under the control of a galactose inducible promoter. EBY100 (Invitrogen, Carlsbad, Calif.) and its derivatives are examples of yeast strains that can be used. Other vectors that can be employed for constructing a yeast surface display library of candidate polypeptides in the present invention include the pPNLS vector as described in the Examples below.

Preferably, the displayed biomolecules are labeled with, e.g., an epitope tag, to facilitate subsequent selection. The Examples below describes the construction of a yeast library of single chain antibodies. To exemplify, an epitope tag (e.g., c-myc or HA) can be fused to the candidate polypeptide to be expressed in a yeast display vector (e.g., pPNLS). The epitope tags enables subsequent labeling of the fusion polypeptide, e.g., via a fluorescently labeled antibody which specifically recognizes the epitope tag (e.g., an anti-HA monoclonal antibody). Other than HA and c-myc, many other polypeptide epitope tags polypeptide sequences described herein or well known in the art can also be used in the invention. See, e.g., U.S. Patent Application 20040146976.

Once candidate biomolecules (e.g., polypeptides) are expressed in a yeast surface displayed library, they can be readily used along with a cognate library of candidate biomolecules to select binding partners. However, as noted above, the yeast surface displayed candidate biomolecules are often subject to enrichment before being used in subsequent library-library screening. Polypeptides expressed on yeast surface can be enriched in a variety of ways. If the protein has a function it may be directly assayed. For example, single chain antibodies expressed on the yeast surface are fully functional and may be enriched based on binding to an antigen. If the displayed polypeptide doesn't have any detectable function that can be easily assayed, its expression may be monitored using an antibody. Detailed guidance for enriching a library of yeast surface polypeptides is provided in the Examples below and also in the art, e.g., Bowley et al., Protein Eng. Des. Sel. 20:81-90, 2007; U.S. Pat. Nos. 6,300,065; 6,423,538; 6,300,065; and U.S. Patent Application 20040146976.

### V. Identifying Binding Partners by Library-library Screening

The invention provides methods for simultaneously identifying multiple binding pairs or binding partners from two cognate libraries of candidate biomolecules (e.g., polypeptides or short peptides). Preferably, the two libraries are respectively expressed and displayed in two different display platforms or replicable genetic package systems. The two libraries of displayed biomolecules (e.g., a library of antibodies and a library of antigens) are then put into contact in order to identify binding partners. Typically, the two libraries are put into contact by mixing in a solution, and incubated under conditions that are conducive to formation of specific interactions between members of the two libraries. As demonstrated in the Examples below, contacting and selection need to be performed under appropriate conditions (e.g., suitable pH and salt concentration) in order to avoid non-specific binding while maintaining contact of the two display platforms throughout the screening process. The conditions under which the screening takes place (e.g., stringency) must also allow disruption of the interaction, subsequent amplification of the libraries, and other procedures such as sequencing. For example, when using a cell based display platform (e.g., yeast), viability of cells and linkage to the displayed biomolecules need to be maintained until amplification of the selected binding pair member.

In general, aqueous conditions are employed for contacting the two libraries and selecting cognate binding pairs, e.g., aqueous buffers. The temperature is not particularly limited but the temperature is preferably less than about 50° C. A typically good temperature range can be, for example, about 0° C. to about 40° C., and more particularly, about 15° C. to about 40° C. In some preferred embodiments, selection of binding pairs from the two libraries is performed at room temperature, 30° C., or 37° C. The Examples below provide more detailed guidance on the various conditions that can be employed in screening a yeast display library against a phage display library, including, e.g., the solutions used for contacting the libraries (e.g., pH and salt), means for selecting and isolating binding partners, washing conditions, and techniques and conditions for disrupting the interaction and amplifying the binders.

Once selective binding is carried out, further steps can be carried out to isolate binding pairs bound via the specific interaction between the displayed biomolecules (e.g., polypeptides). As demonstrated in the Examples below, many methods known in the art can be used for this isolation step, e.g., use of optical, magnetic, electrical, or physical characteristics. In particular, fluorescent and magnetic properties can be used. For example, isolation can be performed on a Flow Cytometer with a magnetic cell separation apparatus. Alternatively, isolation can be carried out with a density gradient, or in a fluidic chamber, or using a centrifugation device.

As an example, the following descriptions and the Examples below provide detailed conditions and procedures for one to screen a phage library against a yeast library for cognate binding pairs. Optimal conditions can be obtained with some variations or adjustments in order to conduct screening of two libraries of biomolecules displayed on other types of display platforms or replicable genetic package systems (e.g., a phage library and a bacterial surface displayed library). For selection of yeast-phage displayed binding pairs, freshly induced yeast cells and freshly precipitated phage are preferred. The yeast cells can be incubated with the phage particles at, e.g., room temperature, 30° C., or 37° C. Suitable buffers for incubating the yeast cells and the phage particles include, e.g., 1% BSA/PBS, 2% BSA/PBS, 0.01% milk/1×10⁻⁵% Tween-20, or 0.05% milk/2×10⁻⁵% Tween-20. The incubation can last for a period of, e.g., at least 10 min, 30 min, 1 hour, 2 hours, 4 hours or longer. The cells can then be pelleted by, e.g., centrifugation, and washed with appropriate solutions (e.g., PBS, 0.5% BSA/PBS, 1% BSA/PBS, or 0.5% BSA/PBS with additional 0.1-2 mM EDTA) to remove free phage. In some embodiments, more than one round of wash (e.g., 2, 3, 4, 5, 6, 7, or more times) may be desired.

Interaction of candidate biomolecules in the first library (e.g., phage displayed antibodies) with members of the second library (e.g., yeast displayed antigens or candidate polypeptides) can be detected via a number of techniques. For example, binding of a phage displayed antibody (e.g., a scFv) to a yeast surface displayed cognate antigen can be readily examined and quantified using flow cytometry methods such as fluorescent-activated cell sorting (FACS), as exemplified in the Examples below. Other known cytology methods can also be used, e.g., microscopy, phase-contrast microscopy, staining methods, fluorochromic dyes, fluorescence microscopy, green fluorescent proteins (GFP), and other flow cytometry methods. As shown in the Examples, confocal microscopy is very useful for identifying phage bound yeast cells.

In some preferred embodiments, phage-yeast binding is analyzed with FACS. FACS is a specialized type of flow cytometry. As demonstrated in great details in the Examples below, this method allows sorting of a heterogeneous mixture of biological cells into two or more containers, one cell at a time, based upon the specific light scattering and fluorescent characteristics of each cell. It is a useful scientific instrument as it provides fast, objective and quantitative recording of fluorescent signals from individual cells as well as physical separation of cells of particular interest. To sort cells by FACS, a cell suspension is typically entrained in the center of a narrow, rapidly flowing stream of liquid. The flow is arranged so that there is a large separation between cells relative to their diameter. A vibrating mechanism causes the stream of cells to break into individual droplets. The system is adjusted so that there is a low probability of more than one cell being in a droplet. Just before the stream breaks into droplets, the flow passes through a fluorescence measuring station where the fluorescent character of interest of each cell is measured. An electrical charging ring is placed just at the point where the stream breaks into droplets. A charge is placed on the ring based on the immediately prior fluorescence intensity measurement and the opposite charge is trapped on the droplet as it breaks from the stream. The charged droplets then fall through an electrostatic deflection system that diverts droplets into containers based upon their charge. In some systems the charge is applied directly to the stream and the droplet breaking off retains charge of the same sign as the stream. The stream is then returned to neutral after the droplet breaks off.

To sort phage-bound yeast cells by FACS, the cells need to be properly labeled to separate phage bound cells and free cells. For example, the suspended yeast cells (both phage free and phage bound cells) can be incubated with a fluorescent label for the phage such as a fluorescent labeled antibody specific for a phage coat protein (e.g., protein VIII as exemplified in the Examples). A number of well known fluorescent materials can be utilized as labels. These include, for example, fluorescein, rhodamine, auramine, Texas Red, AMCA blue, R-phlycoerythrin, B-phycoerythrin, and Lucifer Yellow. After wash, the fluorescently labeled cells (i.e., with phage bound) can be then analyzed, quantified, and isolated via FACS. Typically, as is well known in the art and also described herein, more than one round of sorting can be carried out to identify yeast cells with high affinity phage binders. The cells should be sorted at increasing stringency to isolate the best clones. The cells collected in the final sort can be plated out for clonal analysis and/or amplification if desired.

In some other embodiments, phage bound yeast cells can be selected and separated from free cells by other techniques well known in the art. For example, the cells can be precipitated by phage-specific antibodies immobilized to the surface of a solid support. The solid support is not particularly limited so long as the phage-bound yeast cells can be selectively bound to the surface. For example, it can be a crystalline solid material having a surface, or an amorphous solid material having a surface. In some preferred embodiments, magnetic beads can be employed to select phage bound yeast cells. As demonstrated in the Examples, following incubation of the phage library and the yeast library, pelleted cells can be incubated with an unlabeled antibody that binds to the phage. This is followed by addition to the cell suspension magnetic beads which are coated with a capture molecule (e.g., a secondary antibody) that specifically recognizes the anti-phage antibody. After pelleting and washing, cells bound to the magnetic beads can then be analyzed onto a magnetic column for further analysis. Many metals and magnetic materials can be used in this selection method, e.g., as described in Belcher et al., U.S. patent application Ser. No. 10/665,721 titled “Peptide Mediated Synthesis of Metallic and Magnetic Nanoparticles”.

To exemplify isolation of yeast cells bound by phage, the cells separated from free phage as described above can then be resuspended in appropriate buffers for subsequent studies via either FACS or magnetic beads selection. For example, the cells can be washed and resuspended with an FACS wash buffer (e.g., 0.5% BSA/2 mM EDTA/PBS) for FACS sorting. The washed cells are then incubated with a fluorescently labeled antibody that recognizes the phage (e.g., a-M13 labeled with the fluorescent dye Alexa-546, α-M13-A546). The labeling can be performed at, e.g., at 4° C. or room temperature, for an appropriate period of time (e.g., 10 min, 30 min, 1 hour, 2 hours or longer). If the cells are to be used in magnetic bead selection, an unlabeled antibody for the phage is used. The cells treated with the labeling antibody can then be pelleted again, appropriately washed with a suitable buffer described herein, and then resuspended in a buffer (e.g., FACS buffer). The cell suspension can be analyzed by flow cytometry to isolate yeast cells with bound phage, e.g., with a BD LSR-II instrument for analysis and a BD FACSAria for cell sorting (BD Biosciences, San Jose, Calif.). For magnetic bead selections, magnetic beads coated with a goat-anti-mouse antibody (i.e., capture molecule) are then added to the cells (e.g., on ice or at 4° C.) for 2, 5, 10, 30 minutes or longer. Cells are then again pelleted, resuspended in a buffer (e.g., 0.5% BSA/PBS) before being loaded onto a magnetic column, e.g., one that is commercially available from Miltenyi Biotech (Auburn, Calif.).

In some embodiments, the initial selection rounds of yeast-phage binders are conducted under separate conditions using techniques best suited to each platform. For phage, the library can be selected against the yeast cell library according to typical cell panning methods described herein. The unselected yeast cells are then mixed with the phage from round 1, and magnetic bead selection for phage bound yeast can be completed. The next round of selection utilizes the output phage from the initial cell panning and the output yeast from the magnetic bead selection and subjects them to sorting by flow cytometry. For this and each subsequent round the outputs for both yeast and phage are separated for amplification and then remixed for the next round. The final round of selection will sort single yeast cells into microtiter plates, maintaining the link between the two platforms.

Once phage bound yeast cells have been separated, each binding pair can be subject to additional selection procedures. These include elution of phage from the yeast cell, separate amplification of the phage and the cell, and analysis of the genetic information of the corresponding polypeptides displayed on the binding pair. For example, elution of bound phage from yeast cells can be conducted under a variety of conditions that disrupt the ligand-receptor (epitope) interaction (e.g., antibody-antigen interaction). Typical conditions include enzymatic digestion, high salt or low pH buffers. For example, phage can be eluted from yeast cells with acidic buffers (e.g., buffers with a pH of about 1 to 5, preferably about pH 2 to 3). A buffer with a pH of 2.2 is used in some embodiments to elute phage from yeast cells. In some embodiments, a buffer containing a detergent (e.g., 0.05% Tween-20) can be used to elute phage from yeast cells. In some other embodiments, the interaction can be disrupted by competition with an excess amount of the preselected ligand (e.g., an antigen) in the elution buffer.

After separation of bound phage from yeast cells, the eluted phage can then be amplified by propagation with a suitable host cell using methods as described herein. The cognate yeast cell binder can also be amplified by culturing the cells in appropriate media as described herein. Following separation and amplification, identities of the polypeptides displayed on the phage and the yeast cell can be then determined. Typically, sequences encoding the cognate polypeptide binding partners can be isolated from the corresponding phage vector and the yeast display vector. For example, vectors in the identified yeast cells can be recovered from yeast using the Zymoprep™ kit available from Zymo Research (Orange, Calif.). The phage display vector and the sequence encoding the phage displayed binding pair member can also be isolated with standard phage display techniques, e.g., protocols described in Barbas et al., Phage Display: A Laboratory Manual, Cold Spring Harbor Laboratory Press (2001). The isolated sequences can then be analyzed by, e.g., restriction mapping and/or DNA sequencing. DNA sequencing can be performed by various methods known in the art, e.g., methods described in Messing et al. (Nucleic Acids Res., 9:309, 1981) or Maxam et al. (Meth. Enzymol., 65:499, 1980). Additional teachings for carrying out these routinely practiced techniques are provided, e.g., in Sambrook et al. supra; and Brent et al., supra.

### VI. Screening Systems and Kits

The invention provides screening systems (or binding pair selection compositions) and kits which can be used in the practice of the methods of the invention. Such compositions allow one to simultaneously identify one or more pairs of binding partners from two cognate libraries of candidate biomolecules in accordance with the disclosures provided herein. Typically, the screening systems contain two libraries of candidate biomolecules. As noted above, these two libraries can usually each consist of a plurality of candidate biomolecules in the amount of at least more than 10, 25, 50, 10², 10³, 10⁴, 10⁵, 10⁶, 10⁷, or 10⁸ members. Some of the screening systems are intended for identifying binding pairs from two libraries of candidate polypeptides. In various embodiments, the first library of candidate biomolecules is displayed in a first replicable genetic package, and the second library of candidate biomolecules is displayed in a second replicable genetic package. As described above, the two replicable genetic package systems are typically not identical. In some embodiments, the screening systems contain a first library of biomolecules displayed in a phage display library, and a second library of biomolecules displayed in a yeast display library. Typically, the phage library employs a filamentous phage such as M13, fd or fl phage. The yeast library can utilize various yeast cells as described herein. One example of yeast cells for displaying a library of candidate biomolecules in the screening systems is EBY100. This yeast strain has been used in many studies for surface display of libraries of polypeptides (see, e.g., Bowley et al., Protein Eng. Des. Sel. 20:81-90, 2007; and Feldhaus et al., Nat. Biotechnol. 21, 163-70, 2003).

In some screening systems, one of the libraries can comprise antibodies (e.g., single chain antibodies), and the other library harbors candidate antigens with which immune-reacting antibodies in the first library are to be identified. In some of these systems, members of the antibody library are derived from a non-immunized subject, e.g., naïve antibodies from human spleen cells. With such a screening system, one would be able to identify one or more antibodies which specifically recognize one or more antigens which are expressed and displayed in an antigen library of the system. The antigen library can consist of naturally occurring antigens that are obtained from a source of interest, e.g., cDNAs isolated from a tumor cell or a healthy cell of immunological importance (e.g., bone marrow cell). The antigen library can also consist of antigens that are artificially generated from a single naturally occurring antigen, e.g., fragments of a viral or bacterial antigen. In some other systems of the invention, the antibody library consists of antibody clones which are generated against a specific antigen. For example, the antibodies can be a pool of monoclonal antibodies generated via hybridoma technology against a viral protein (e.g., a HIV polypeptide or a hepatitis C virus antigen). On the other hand, the antigen library can be one which contains randomly generated peptide fragments of the antigen. These systems can be used, e.g., to identify cognate antigenic fragments to which some members of the antibody library recognize. Other than these specifically illustrated screening systems, one of skill would readily appreciate that many other embodiments exist with which binding pairs from two cognate libraries of candidate polypeptides can be identified.

In a related aspect, the invention provides kits which can be employed to practice the methods described herein. In general, the kits include two vectors for displaying two cognate libraries of candidate biomolecules. Typically, the vectors are intended to display the candidate biomolecules in two different replicable genetic package systems. Some of the kits are intended for identifying binding pairs from two libraries of candidate polypeptides (e.g., antibodies and polypeptide antigens). In these embodiments, the kits include a first vector for displaying a library of candidate antibodies in a first replicable genetic package and a second vector for display a library of polypeptide antigens in a second replicable genetic package. Specific vectors and corresponding replicable genetic package systems for making the kits are described herein. For example, some of the kits include a vector for displaying a library of candidate polypeptides on phage, and a second vector for displaying a cognate library of candidate polypeptides on yeast. In some of these kits, the phage vector is a phagemid vector, and the yeast surface display vector can be any suitable vector described herein. The kits can additionally include host cells and other agents necessary for expressing the vectors. For example, some of the kits can contain an E. coli cell (e.g., XL1-Blue cell) for expressing a phage display vector and a yeast cell (e.g., EBY100) for expressing a yeast display vector, and, if necessary, a helper phage for propagation of phage displaying a candidate polypeptide expressed from a phagemid vector.

The screening systems and kits usually can additionally include an instruction or instruction sheet on how to carry out the selection of binding pairs from the two libraries. Detailed information on the instruction varies depending on the specific vectors used and the candidate biomolecules to be selected. As an example, some of the kits include a vector for displaying a polypeptide antigen library on phage (e.g., pFRAG vector or pComb3 vector) and a vector for displaying a single chain antibody library on yeast (e.g., pPNLS vector). Similarly, some of the screening systems contain libraries of candidate biomolecules which are expressed on such vectors. In these kits or screening systems, the instruction sheet can include specific information on, e.g., how to contact members of the two display libraries, how to isolate specific binding pairs, and how to amplify the isolated binders. Such information is disclosed herein, e.g., in the Examples below.

The screening systems or kits of the invention can also include various other components or agents which are helpful to carrying out the intended functions, e.g., a buffering agent, a preservative or a protein-stabilizing agent. Additional agents or reagents that can be included in the screening systems or kits are described above and in the Examples below.

### EXAMPLES

The following examples are provided to further illustrate the invention but not to limit its scope. Other variants of the invention will be readily apparent to one of ordinary skill in the art and are encompassed by the appended claims.

### Example 1

### Yeast Display Library Construction and Enrichment

This Example describes display and selection of a library of anti-HIV-1 scFcs expressed on yeast cell surface. The materials and methods employed in this study are described below.

Cell lines and media used: Yeast strain EBY100 (GAL1-AGA 1::URA3 ura3-52 trp1 leu2Δ1 his3Δ200 pep4::HIS2 prb1Δ1.6R can1 GAL) was maintained in YPD broth (Difco). After transfection of EBY100 with the vector pPNLS cells were maintained in SDCAA medium (6.7 g/L yeast nitrogen base, 5 g/L casamino acids, and 20 g/L dextrose, 9.67 g/L NaH₂PO₄.2H₂O, and 10.19 g/L Na₂HPO₄.7H₂O) and on SD-HUT plates (Qbiogene). Yeast surface expression of scFv was induced by transferring to SGR medium (same as SDCAA, replacing dextrose with 20 g/L each galactose and raffinose and 1 g/L dextrose). E. coli XL1-Blue cells were used for cloning and preparation of plasmid DNA grown in SB media (30 g/L bactotryptone, 20 g/L yeast extract, and 10 g/L MOPS) supplemented with 20 mM glucose.

Antigens and antibodies used: Monomeric gp120_{JR-FL} and soluble CD4 were purchased from Progenics (Tarrytown, N.Y.) and gp120_{JR-CSF} was procured under contract from Advanced Products Enterprises (Maryland). The human α-gp120 mAbs used in this study are IgGs b12 (Burton et al., Science 266:1024-7, 1994), 2G12 (Trkola et al., J. Virol. 70:1100-8, 1996) (provided by Gabriela Stiegler and Hermann Katinger), C11 (Moore et al., J. Virol. 68:6836-47, 1994), and F2A3 (provided by James Robinson). Antibodies were biotinylated using EZ-Link Sulfo-NHS-Biotinylation Kit from Pierce. Mouse mAbs α-HA (12CA5) and α-c-myc (9E10) were obtained from Roche. Fluorescent reagents goat-α-mouse-Alexa 488 (GaM-A488), GaM-A633, GaM-A546, streptavidin-phycoerythrin (SA-PE) and SA-A633 were obtained from Molecular Probes. The yeast nonimmune scFv library was received from M. Feldhaus, Pacific Northwest National Laboratory (PNNL).

Vector modifications and X5 cloning: The yeast display vector pPNL6 was received from M. Feldhaus (PNNL). Two SfiI restriction sites were inserted before and after the scFv, matching the SfiI sites of the pComb3X phage display vector, using the QuikChangeII site directed mutagenesis kit (Stratagene) with the following oligonucleotides:

1229Sfi:

(SEQ ID NO: 1)

5′-GGTGGTTCTGCTAGGGCCCAGGCGGCCTGCGGTGGCGG-3′;
1229Sfi_AS:

(SEQ ID NO: 2)

5′-CCGCCACCGCAGGCCGCCTGGGCCCTAGCAGAACCACC-3′;
1419Sfi:

(SEQ ID NO: 3)

5′-CAGGTCGACTGCGGCCAGGCCGGCCAAGGGGGCGGATCC-3′;
and
1419Sfi_AS:

(SEQ ID NO: 4)

5′-GGATCCGCCCCCTTGGCCGGCCTGGCCGCAGTCGACCTG-3′

The sequence of the modified vector, pPNLS, was verified by DNA sequencing. ScFv X5 was cloned into pPNLS by digestion of X5 from pComb3x with Sfi/, gel purified and extracted from the gel with QIAquick gel extraction kit (Qiagen); then X5 was ligated into the similarly treated pPNLS and correct incorporation verified by DNA sequencing. The X5-pPNLS vector was transformed into EBY100 yeast using reactions of the high-efficiency lithium acetate transformation (Gietz and Woods, Methods. Enzymol. 350:87-96, 2002).

Yeast display library construction: The FDA2 scFv kappa and lambda libraries for phage display were completed as described in Zwick et al., J Virol 75:10892-905, 2001; Zwick et al., J Virol 77:6965-78, 2003; and Barbas et al., Phage Display: A Laboratory Manual, Cold Spring Harbor Laboratory Press (2001). Briefly, RNA was isolated from the bone marrow of patient FDA2, an HIV-1-seropositive individual with broad HIV-1 neutralizing Ab titers, and used to prepare the scFv libraries in pComb3X. The size of each library was estimated at 10⁷ members. These libraries were excised from pComb3X by digestion with Sfi/, gel purified and extracted from the gel. The libraries were ligated into SfiI digested and purified pPNLS vector; the ligation reaction was purified using QIAquick PCR purification kit (Qiagen) and transformed into XL1-Blue electroporation-competent cells (Stratagene). Dilution plates indicated the size of the libraries to be approximately 10⁹, which exceeds the library diversity by 2 orders of magnitude. Inserts of the correct size were found in 100% of tested vectors. The pPNLS-scFv libraries were then transformed into yeast EBY100 using 10 “2×” reactions of the high-efficiency lithium acetate transformation (Gietz and Woods, Methods. Enzymol. 350:87-96, 2002); the reactions were pooled and grown in SDCAA at 30° C. to saturation (about 40 hours). The size of each library in yeast was estimated at 1.5×10⁷ and 2.7×10⁷ members for the kappa and lambda libraries respectively.

Yeast screening and analysis: The yeast libraries were grown as previously described (Feldhaus et al., Nat Biotechnol 21, 163-70, 2003). Typically, yeast were grown in SDCAA approximately 18-22 hours at 30° C. and then transferred to SGR for approximately 16-18 hours at 20° C. in culture volumes appropriate for the size of the library. For the X5-spiked library (X5 mixed with the nonimmune library at 1:1×10⁶) an initial magnetic bead selection round was completed as previously described in Feldhaus et al., Nat Biotechnol 21, 163-70, 2003. Briefly, 10¹⁰ yeast cells were incubated with 100 nM gp120 (pre-complexed with sCD4) and 200 nM biotinylated-2G12 in 10 mL FACS wash buffer (PBS/0.5% BSA/2 mM EDTA), washed three times, incubated with 200 μL Miltenyi Macs anti-biotin magnetic particles in 5 mL wash buffer, washed once then resuspended in 50 mL wash buffer and loaded onto the LS Macs column on the magnet. Cells were eluted by removing the column from the magnet, adding 7 mL media and forcing through the column with a plunger. The cells were grown overnight in 100 mL SDCAA+penicillin/streptomycin. The X5-spiked library was then further selected by three additional flow cytometry sort rounds, as for the FDA2 library.

For the first two selection rounds of the FDA2 libraries, at least 2×10⁸ yeast cells were stained in 500 μL volumes, and 1×10⁷ yeast cells in 100 μL volumes were stained for subsequent sort rounds. Yeast cells were incubated with 100 nM gp120, 200 nM biotinylated α-gp120 antibody (2G12 or C11), and 5 μg/mL α-HA (12CA5) antibody for 30 minutes at room temperature in FACS wash buffer, then washed 3 times in ice cold wash buffer. The cells were probed by incubation with 5 μg/mL each of SA-PE and GaM-488 for 30 minutes on ice in the dark, then washed 3 times again and resuspended in 6 mL or 3 mL FACS wash buffer (depending on number of cells) for sorting by flow cytometry. Selections were performed using a BD Bioscience FACS Vantage DiVa set for purifying selection, and sort gates were determined to select the desired double positive cells. Collected cells were plated on SD-HUT plates with Penn/Strep and grown at 30° C. for approximately 2 days. Cell were then resuspended and amplified for the next round, or individual colonies were picked after the final selection round.

Characterization of single scFv clones: Analysis of single yeast clones was performed by first isolating the plasmid from the yeast cells using the Zymoprep yeast plasmid miniprep kit from Zymo Research. The plasmids rescued from yeast were then transformed into electrocompetent XL 1-blue E. coli for amplification of plasmid DNA which was purified using the QIAprep spin miniprep kit from Qiagen and the scFv insert was sequenced. A representative clone for each sequence was used for subsequent analysis. Individual yeast clones were grown in SDCAA approximately 18-22 hours at 30° C. and then transferred to SGR for approximately 16-18 hours at 20° C. typically in 1 mL volumes as previously described in Feldhaus et al., Nat Biotechnol 21, 163-70, 2003. For FACS analysis 5×10⁵ cells were stained in 50 μL volumes with 30 minute incubations and washed twice with 200 μL with FACS wash buffer in a V-well 96-well plate. To assess binding to gp120, four concentrations of gp120 (0-200 nM) were used the presence or absence of 40 nM sCD4, cells were washed and then incubated on ice with biotinylated-2G12 and α-c-myc. After further washing, the cells were incubated on ice with fluorescent reagents SA-PE and GaM-A633, washed again and resuspended in 150 μL FACS wash buffer.

Using the above described materials and methods, a yeast surface displayed library of scFvs for HIV-1 gp120 was constructed and selected. The anti-HIV-1 library utilized in this study was chosen for several reasons. First, serum studies of a long-term non-progressive (LTNP) patient FDA2 infected with a Glade B virus, showed the ability to neutralize HIV-1 entry into cells for a broad range of isolates (primarily within Glade B). A recent study by our lab also showed that the IgG fraction of serum is responsible for the neutralization. Further, when the gp120 binding fraction of IgG is depleted by affinity chromatography with monomeric gp120_{JR-FL}, there is no neutralization of JR-FL virus and the neutralization of a Glade A virus and a Glade C virus were reduced by at least 50%. From this study we have concluded that it may be possible to isolate broadly neutralizing antibodies by selecting the FDA2 IgG-derived library against monomeric gp120.

Second, despite many phage panning attempts utilizing many different HIV-1 envelope constructs and both scFv and Fab display libraries, no antibodies have been isolated that can account for the observed sera neutralization data. This suggests that it may not be possible to isolate these specificities by phage display. However, the FDA2 libraries have yielded several interesting antibody specificities that have been described in detail: Fab Z13 (Zwick et al., J Virol 75:10892-905, 2001), which targets the membrane proximal external region of HIV-1 gp41; scFv 4KG.5 (Zwick et al., J Virol 77:6965-78, 2003), which targets a unique HIV-1 gp120 epitope that distinguishes the mAb b12 from other CD4bs antibodies; and Fab X5 (Moulard et al., Proc. Natl. Acad. Sci. USA 99:6913-8, 2002; and Labrijn et al., J. Virol. 77:10557-65, 2003), which targets a CD41 epitope on gp120. The antibody X5 has also been expressed as an scFv and for this study was used as a positive control for gp120 binding. Third, since both scFv and Fab libraries in phage were already created this would allow us to quickly generate a yeast-displayed version of the library that should be similar in composition, allowing a direct comparison of the two display formats using the same library and same antigens.

Generation of the yeast surface display vector pPNLS: The first reported nonimmune scFv library for yeast display utilized the vector pPNL6 (Feldhaus et al., Nat Biotechnol 21, 163-70, 2003). We modified pPNL6 to include two SfiI restriction enzyme sites that matched the cloning sites in the phage display vector pComb3X. This allowed scFv fragments to be shuttled between the yeast vector, designated pPNLS, and pComb3X. The first SfiI site was inserted directly after the HA affinity tag and (G₄S)₃ linker sequence, and the second site was inserted directly before the c-myc affinity tag ensuring that both tags would be present on yeast-displayed scFvs.

There are two differences between a previously described nonimmune scFv yeast library and the current FDA2 immune scFv yeast library: the order of the variable heavy (V_{H}) and variable light (V_{L}) domains are reversed in the FDA2 library so that the V_{L} is first, and the linker of the FDA2 library is (G₄S)₃RSS instead of (G₄S)₃. To ensure that these differences had no effect and that gp120 could be used as an antigen for yeast display, we first subcloned scFv X5 into pPNLS and verified binding to gp120 via flow cytometry. Unlike many other selection protocols for yeast display, the antigen gp120 was not directly tagged, since we did not want to obscure any epitopes or alter gp120's conformation by biotinylation. Instead a mAb to a non-competitive epitope was biotinylated and used to sandwich gp120, which was then visualized with streptavidin-phycoerythrin (SA-PE). The binding affinity of scFv X5 for monomeric gp120 was measured by titering the amount of gp120 in the presence and absence of sCD4 and measuring the mean fluorescence intensity (MFI) of antigen binding; equilibrium binding constants were 1.1 nM and 14.5 nM respectively, in agreement with previously published results as estimated from ELISA for Fab X5 (2 nM and 10 nM).

To estimate the affinity of an scFv displayed on yeast the concentration of antigen in solution is titrated and the mean fluorescence intensity (MFI) of antigen binding of only the scFv positive cells is plotted against the antigen concentration to obtain the estimated equilibrium binding constant (K_{D}).

Validating library selection protocols with X5-spiked library: To verify that a sandwich approach could be used for selection we mixed X5 displaying yeast into a nonimmune scFv library at 1×10⁶. To select X5 yeast cells, we incubated cells with gp120 pre-complexed with sCD4, then incubated with biotinylated-2G12 and the cells were selected using streptavidin. The first round of selection utilized a magnetic bead sort with streptavidin microbeads followed by three rounds of cell sorting by flow cytometry using fluorescent streptavidin.

To our surprise we isolated not only X5 from this selection but several other scFvs from the nonimmune library. We characterized several of these clones for their sequence and for their binding to gp120. All scFv had increased affinity for gp120 in the presence of sCD4, as would be expected since gp120+sCD4 was utilized for the selection. Interestingly, all isolated scFvs had the same heavy chain germline gene usage. It has been noted previously (Huang et al., Proc. Natl. Acad. Sci. USA 101:2706-11, 2004) that many CD41 antibodies (antibodies whose affinity for gp120 is increased in the presence of CD4) come from the VH1 heavy chain germline (primarily 1-69 and 1-24). However, the binding to gp120 for all scFv was relatively weak (100-200 nM) and we therefore moved onto the selection of the FDA2 immune library.

Creating yeast-displayed FDA2 scFv libraries: The preparation of Fab and scFv libraries from donor FDA2 have previously been completed and described (Zwick et al., J Virol 77:6965-78, 2003; and Moulard et al., Proc. Natl. Acad. Sci. USA 99:6913-8, 2002). Two scFv phage display libraries were originally generated from the FDA2 donor; both used the same heavy chain PCR pool and overlap PCR was used to combine with kappa and lambda light chains in separate libraries. Here each library of scFv-encoding cassettes was excised as a single SfiI fragment from pComb3X, ligated into similarly digested pPNLS and transformed into electrocompetent XL1-Blue E. coli. The number of independent colonies following transformation was approximately 10⁹, which is two orders of magnitude larger than the estimated diversity of the original libraries. Twenty clones (ten from each library) were analyzed by digestion and all had scFv inserts of the correct size. We also sequenced these twenty clones and compared the distribution of heavy chain germline gene usage to previous reports. These libraries were transfected into EBY100 yeast cells with an estimated 2×10⁷ independent clones. Since the original libraries in pComb3X were approximately 10⁷ in size, sequence composition of the libraries in both display formats was expected to be similar. Another twenty yeast clones were analyzed by flow cytometry for anti-HA and anti-c-myc binding. As expected all twenty were HA positive (N-terminal tag) but only nine clones were c-myc positive (C-terminal tag). However, when the sequences were analyzed all twenty had full length in-frame scFv sequences and the c-myc tag. Most likely the reversed order of the V_{H} and V_{L} domains blocks the anti-c-myc antibody from binding for some scFv clones. Therefore, for all library selections and single clone analysis we utilized anti-HA staining to assess surface expression of scFv.

Selection of yeast surface displayed scFv library using flow cytometry: scFv FDA2 yeast-displayed libraries were subjected to multiple rounds of affinity selection sorting for gp120 recognition and the progress of the sort was monitored by the percentage of induced cells binding to gp120. After the first round, secondary-only controls (streptavidin only and capture antibody) were used to determine the appropriate sort gate setting so only gp120-binding yeast were collected. The biotinylated antibodies for gp120 visualization were C11 and 2G12, which were used alternately to minimize selection of nonspecific clones. These two antibodies were chosen because their epitopes show no or limited overlap with most of the known epitopes on gp120 (Moore and Sodroski, J Virol 70:1863-72, 1996). Typically, only 3 to 4 rounds of selection were necessary to achieve 100% enrichment for specific gp120-binding clones. During the final round of selection we utilized the flexibility of flow cytometry sorting to isolate three distinct populations: all gp120 binding cells, cells with the brightest antigen binding fluorescence, presumably the highest affinity binders and a population of cells that lost binding to gp120 once it was complexed with sCD4. Following the final round, individual clones were picked and grown for characterization and plasmid isolation. Separate selection rounds were completed for gp120_{JR-FL} and gp120_{JR-CSF}, although most selected clones bound both, and subsequent analysis utilized the selecting gp120 for each clone.

Flow cytometry selection of gp120 binding scFv: Cells were double labeled with α-HA/α-mouse FITC and gp120/biotinylated α-gp120/streptavidin-PE. Each bivariate plot represents sequential selection rounds wherein the gated subpopulation has been sorted, amplified and subjected to the next round of selection. Secondary controls (not shown) were analyzed and sort gates were determined so that only gp120 binders were selected. The table shows the number of cells analyzed, collected and the percentage of scFv positive cells that bind to gp120 for each selection round.

One complication faced during the selection of the FDA2 libraries was that as selection rounds progressed, the percentage of induced cells decreased (as measured by scFv positive cells). After these selections were completed it was learnt that the nonimmune library from PNNL had a contaminating yeast strain C. parapsilosis, which overtakes the cultures with repeated outgrowths and selections. Although we made our own library, we had utilized EBY100 yeast cells obtained from PNNL and therefore contamination could explain our observations. C. parapsilosis yeast have a very different cell morphology when examined by phase contrast microscopy, and since each selection round is visualized by FACS, it is known very early in the selection process if there is contamination (C. parapsilosis obviously does not include any of the epitope tags). There are also several ways to minimize contamination including a “pre-sort” for only scFv displaying cells.

### Example 2

### Materials and Methods for Examining Interaction Between Yeast/phage Libraries

This Example describes materials and methods employed in analyzing binding between yeast displayed scFv antibodies and phage displayed polypeptide antigens. Two existing libraries were utilized in this study, the FDA2 scFv library displayed on yeast (described above) and a polypeptide library of fragmented gp160 displayed on phage. Addition materials and methods employed in this study are described below.

Cell lines and media: Yeast strain EBY100 (GAL1-AGA1::URA3 ura3-52 trp1 leu2Δ1 his3Δ200 pep4::HIS2 prb1Δ1.6R can1 GAL) was received from M. Feldhaus, Pacific Northwest National Laboratories (PNNL) and was maintained in YPD broth (Difco). After transfection plasmid-containing yeast cells were maintained in SDCAA* medium (6.7 g/L yeast nitrogen base, 5 g/L casamino acids, and 20 g/L dextrose, 14.7 g/L sodium citrate and 4.29 g citric acid, pH-4.5) and on SD-HUT plates (Teknova, Hollister, Calif.). Yeast surface expression was induced by transferring to SGR medium (6.7 g/L yeast nitrogen base, 5 g/L casamino acids, and 20 g/L galactose, 20 g/L raffinose, 1 g/L dextrose, 9.67 g/L NaH₂PO₄.2H₂O, and 10.19 g/L Na₂HIPO₄.7H₂O). E. coli XL1-Blue was used for cloning and preparation of plasmid DNA; grown in LB media (10 g/L bactotryptone, 5 g/L yeast extract, and 10 g/L NaCl). For preparation of phage, E. coli were grown in SB media (30 g/L bactotryptone, 20 g/L yeast extract, and 10 g/L MOPS).

HIV-1 gp160 fragment library: Construction of the library was described in detail in Zwick et al., J. Virol. 75:10892-905, 2001. Briefly, a KpnI-BamHI fragment of the gp160 gene encoding most of gp120 (except the first 12 amino acids) and the gp41 ecto- and transmembrane domains was cut from the vector pSVIII env (Sullivan et al., J Virol 69:4413-22, 1995) and cloned into the pUC19 vector for both HXB2 and SF162 HIV-1 isolates. The entire pUC19 vector containing the gp160 DNA was randomly digested with DNaseI. The resulting fragments were blunt-end ligated to a flanking sequence containing a SfiI restriction site. The ligation products were separated using Tris-borate-EDTA polyacrylamide gel electrophoresis, and fragments in the range of 50 to 250 by were electroeluted from gel slices. The fragments were cut with SfiI restriction endonuclease and cloned into the vector pFRAG which was derived from pComb3 (Williamson et al., J Virol 72:9413-8, 1998). The libraries contained 6×10⁷ to 7×10⁷ independent clones.

Antibodies for labeling yeast displayed scFv and phage: Mouse mAb α-FIA (12CA5) was purchased from Roche (Indianapolis, Ind.) and α-M13 was purchased from GE Healthcare (Buckinghamshire, England). Conjugation dyes Alexa647- and Alexa546-carboxylic acid, succinimidyl ester were obtained from Invitrogen (Carlsbad, Calif.). Conjugation of Alexa dyes to mAbs was carried out according to the manufacture's directions. Briefly, 10 mg/mL solution of dye in DMSO was added to the antibody at a 10× molar ration, incubated at room temperature for 30 minutes and the reaction stop by addition of excess sodium azide. Labeled antibodies were then dialyzed into 2 mM NaN₃/PBS and stored in the dark at 4° C.

Yeast cell growth and induction: The typical growth and induction of yeast cells was modified slightly to allow selection rounds to proceed more quickly, and SDCAA (pH 4.5) was utilized ensure minimal bacterial growth. If yeast cells were grown overnight at 30° C. (16-24 hours) the starting cell density was between 1×10⁵ and 1×10⁶ c/mL and the cell density was monitored so growth was stopped once saturation was reached. Alternatively cells were grown for 6-8 hours at 30° C. to reach saturation (−1×10⁸ c/mL) from a starting density of 1-2×10⁷ c/mL. For uncontaminated yeast cultures the typical density of saturation observed was between 1 and 1.5×10⁸ c/mL; if the density as measured by OD₆₀₀ exceeded 2×10⁸ c/mL this was indicative of an undesired contaminate yeast. Yeast were induced by transferring to SGR media at a starting density of 1×10⁷ c/mL and incubated overnight (˜16-18 hours) at 20° C. Other groups have reported the best induction percentage with 36 hours at 20° C., however with non-contaminated cultures we observe 85% induction (the highest that has been reported for this system) with only 16-18 hours. Typically yeast cells double once or twice during the induction, if the density as observed by OD₆₀₀ exceeds 4×10⁷ c/mL this is again indicative of an unwanted contamination. Further, the typical contaminating strains we have observed grow significantly faster at the lower temperature so to minimize this issue we prefer shorter induction times.

Phage display selection of TJ7 and creation of TJ7.15: HxB2 and SF162 libraries were panned against 2F5 antibody as described in Barbas et al., supra (protocols 10.4 and 10.5). For selection, 2F5 was used at 1 μg in each of two ELISA plate wells. After the first round of selection the number of wells panned against was reduced to one well. The number of washes with 0.5% Tween/TBS per well was three for the first two rounds, two for the third round, and five for the fourth round. Phage were eluted with 50 μl of trypsin (10 mg/ml). Ten clones were selected from round 4 panning and tested by ELISA. Of those clones, 6 of 10 were positive by ELISA as determined by A₄₀₅ three-times over background. Sequencing results show that the positive clones all contain the core 2F5 epitope, DKW.

TJ1

(SEQ ID NO: 5)

LEADAGGVHSLIEESQNQQEKNEQELLELDKWASLWNWFNITNWPPPAGA
TJ4

(SEQ ID NO: 6)

LEADAGGVIEESQNQQEKNEQELLELDKWASLSPPAGA
TJ5

(SEQ ID NO: 7)

LEADAGGVIEESQNQQEKNEQELLELDKWASLSPPAGA
TJ6

(SEQ ID NO: 8)

LEADAGGVHSLIEESQNQQEKNEQELLELDKWASLWNWFNITNWPPPAGA
TJ7

(SEQ ID NO: 9)

LEADAGGVHSLIEESQNQQEKNEQELLELDKWASLWNWFNITNWPPPAGA
TJ9

(SEQ ID NO: 10)

LEADAGGVIEESQNQQEKNEQELLELDKWASLSPPAGA

A phage clone containing the Z13e1 epitope was generated by mutating the TJ7 phage clone from WNWFNIT (SEQ ID NO:13) to WNWFDIT (SEQ ID NO:14) using QuikChangeII Site-Directed Mutagenesis Kit (Stratagene) with the following primers. The point mutation was verified by DNA sequencing and the phage clone renamed TJ7.15.

A118g sense:

(SEQ ID NO: 11)

5′ GGGCAAGTTTGTGGAATTGGTTTGACATAACAAATTGGCCAC 3′;
and
A118g antisense:

(SEQ ID NO: 12)

5′ GTGGCCAATTTGTTATGTCAAACCAATTCCACAAACTTGCCC 3′

The point mutation was verified by DNA sequencing and the phage clone renamed TJ7.15.

Confocal microscopy: Yeast cells expressing Z13e1 scFv bound with TJ7.15 phage are analyzed with confocal microscopy by the following procedure. The number of cells stained was 1×10⁶ per condition (see Table 1). Cells were initially washed twice with PBS and then washed two times after each stain and after fixing. Antibodies were used at 1 μg/100 μl of cells in PBS. Biotinylated gp41 was used at 2 μg/100 μl of cells. Cells were incubated first with anti-HA for 30 minutes at room temperature. Phage or biotin-M41xt was bound for 1 hour at room temperature. Anti-M13 or streptavidin-A633 was incubated 30 minutes at room temperature. Formaldehyde (3.7%) was used to fix the cells for 10 minutes room temperature. After washing, Triton X-100 (0.1%) was added for 10 minutes at room temperature and washed. DAPI (125 μg/200 μl) staining was done for 30 minutes at room temperature. Cells were washed and resuspended in left over wash buffer (approximate volume 30 μl). Antifade was added at 10 μl per 30 μl of cells.

TABLE 1
Staining conditions for confocal microscopy

| Yeast scFv | Phage | Peptide-biotin | Fluorescent Antibody |
|---|---|---|---|
| Z13e1 | None | None | anti-HA-A647 |
| Z13e1 | None | None | Anti-HA-A647/anti-M13-A546 |
| Z13e1 | TJ7.15 | None | anti-HA-A647/anti-M13-A546 |
| Z13e1 | None | M41xt | anti-HA-A647/SA-A633 |
| Z13e1 | TJ7 | None | anti-HA-A647/anti-M13-A546 |
| X5 | TJ7.15 | None | Anti-HA-A647 anti-M13-A546 |

Selection of yeast-phage pairs: Multiple incubation and washing conditions have been tested, but they all follow roughly the same procedure. Freshly induced yeast cells and freshly precipitated phage were always used for selections. Yeast cells are incubated with phage (and a-HA-A647 for flow cytometry) at either room temperature or 37° C. for at least 1 hour, then pelleted by centrifugation. Cells are then washed at least once with FACS wash buffer (0.5% BSA/2 mM EDTA/PBS) then incubated with α-M13-A546 (or unlabeled α-M13 for magnetic bead selection) at 4° C. for at least 30 minutes. Yeast cells are again pelleted and washed at least once and then resuspended for FACS buffer. For magnetic bead selections 200 μL of goat-anti-mouse Miltenyi Macs microbeads are added in 5 mL wash buffer for 10 minutes on ice then diluted with 40 mL wash buffer, cells pelleted and then resuspended in 50 mL wash buffer to load onto the magnetic column. For flow cytometry a BD LSR-II instrument was used for analysis and a BD FACSAria was used for cell sorting.

### Example 3

### Enriching Binders from Yeast-scFv Library and Phage-displayed Antigen Library

This Example describes results obtained from experiments directed to identifying binders between yeast displayed scFv antibodies and phage displayed polypeptides antigens. Materials and Methods employed in these experiments are described in Example 2.

To select binding partners from the yeast displayed single chain antibodies and the phage displayed gp160 fragments, we first attempted to validate conditions for separation of yeast and phage. The first criterion examined was if phage and yeast could be separated without detrimental effects to either the yeast or phage. This is normally not a concern with phage display since the phage virus is very difficult to destroy. However, yeast display requires the viability of cells and maintenance of the scFv-encoding plasmid. We were unsure what effect the typical phage elution conditions would have on the yeast cells. To test the yeast viability, we incubated them with PBS control, 10 mg/mL trypsin, or pH 2.2 elution buffer and there appeared to be no loss in yeast viability for either elution condition as measured by titration on SD-HUT plates. The cells were also grown and induced as usual and the level of scFv induction was measured by α-HA stain in flow cytometry. Here we observed fluctuations in the scFv levels after treatment of trypsin but treatment with pH 2.2 appeared to have no effect compared to a PBS control after a single growth and induction round. Additionally, we tested several different incubation conditions that have been used for phage panning. We observed no changes in yeast viability or plasmid maintenance when incubated with phage in 10% milk protein and 0.05% Tween-20 with incubation temperatures up to 37° C. Normally this detergent would be expected to lyse cells, but apparently the yeast cell membrane is protected from the effects of the detergent by its cell wall.

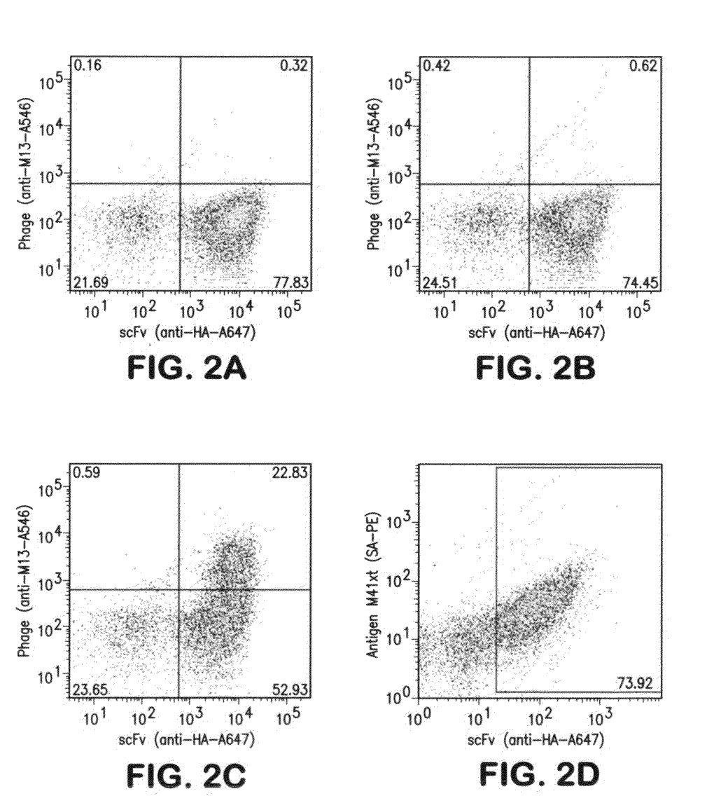

We then identified optimal conditions for phage and yeast binding. For the library-library selection to be successful, single cell flow cytometry sorting is utilized—and therefore conditions must be developed to visualize phage binding to yeast cells by flow cytometry. To determine appropriate staining conditions for yeast-phage binding and fluorescence, we used a single yeast-scFv clone (Z13e1) and a phage-fragment (TJ7.15) containing the Z13e1 epitope. The antibody clone Z13 was originally isolated both as a Fab and scFv from the FDA2 library displayed on phage. Variant Z13e1 Fab was isolated from a mutagenesis library by phage display with 100-fold increased affinity for the epitope relative to the parental Z13 (Nelson et al., J. Virol. 81:4033-4043, 2007). Finally, Z13e1 was cloned as an scFv into the yeast display vector. The mAb 2F5 was originally used to isolate several specific peptides from the antigen library. However Z13e1 cannot select from the fragment library because the gp160 isolates utilized (SF162 and HXB2) contain the sequence WNWFNIT (SEQ ID NO:13) whereas Z13e1 requires the sequence WNWFDIT (SEQ ID NO:14). Using Quik-change mutagenesis on phage-fragment clone TJ7, we changed the asparagine to an aspartic acid creating phage-fragment TJ7.15 giving us a positive and a negative control for phage-yeast binding. Shown in FIG. 2 is yeast-Z13e1 binding to only secondary antibody, TJ7 or TJ7.15 phage-fragments. On the FACS bivariate plots of the figure, the x-axis indicates display of the scFv on the surface of the yeast cells (as measured by fluorescent α-HA antibody), and the y-axis shows binding of the yeast cells to phage (measured by fluorescent anti-phage antibody).

One of the major problems when using cells as panning antigens for phage display is non-specific binding of the phage to the cells. However, with yeast display there is a built-in control for nonspecific binding of phage because at least 15% of yeast cells do not display the induced scFv on their surface. If phage-yeast binding was observed in the upper-left quadrant of the bivariate plot this would indicate non-specific binding of phage and yeast. We have never observed non-specific binding of yeast and phage even with the non-stringent binding condition of only 1% BSA/PBS.

Clearly there is a specific interaction occurring between Z13e1-yeast and the phage that is abolished by a single point mutation. We also examined other yeast-displayed scFv including X5 and did not observe any binding to either TJ7 or TJ7.15 phage. These experiments have been repeated three times with different preparations of phage, different growth and induction preparations of yeast cells and with multiple incubation and washing conditions with the same results observed.

There are two aspects of the Z13e1-TJ7.15 FACS plot of FIG. 2 that are worth noting. First, when a clonal population of yeast-scFv is bound to the target antigen the typical FACS plot includes the uninduced population of cells and then the induced cell population appears as a diagonal line (see panel D). The level of scFv expression varies from cell to cell, so those with more scFv can obviously bind to more antigens making the fluorescence brighter. But the size of M13 phage is huge compared to a soluble protein, typically 6 nm in diameter and up to 2000 nm (2 μm) in length. The α-M13 antibody used to label phage binds to the minor coat protein pVIII, and phage staining should be fairly bright even if only very few total phage are bound to yeast cells. Therefore the reason we don't observe the diagonal orientation of cells is that a limited number of phage can bind to the yeast cells regardless of the number of scFv displayed on the surface. Second, two separate populations of scFv positive cells are observed. It may be possible that the yeast cells are not a clonal population. Alternatively, it could be due to the way that phage and yeast interact in solution, which may be difficult to model given that phage are not rigid. It has been observed that phage tend to aggregate and can become tangled when concentrated, especially when labeled with fluorescent antibodies.

To see if the initial phage-yeast incubation had any effect on the amount of double positive cells we varied the incubation times for Z13e1-yeast binding to TJ7.15 phage from one hour up to four hours at both room temperature and 37° C. with no major variations. However, there was variation observed between different phage preparations, with as high as 40% and as low as 5% double positive cells. With phagemid display, the phage preparations contain both wild type phage (derived from the helper phage) and recombinant phage and it has been observed for the typical helper phage such as M13K07 and VCSM13, that the levels of display are low (Bradbury et al., J. Immunol. Methods. 290:29-49, 2004). Although we are using excess amounts of phage, perhaps the actual concentration of the TJ7.15 clone is low and therefore we have not reached equilibrium binding conditions. The use of helper phage containing conditional pIII deletions (which display high levels of recombinant protein) could clarify these results.

Fluorescence confocal microscopy was also utilized in order to gain a better understanding of the yeast-phage interaction. Yeast cells displaying Z13e1 scFv were stained with fluorescent a-HA for scFv expression, and TJ7.15 phage with fluorescent α-M13. We obtained confocal sections from cells with the anti-phage stain in red and the anti-scFv stain in blue. As expected the scFv stain is diffuse and located exclusively at the edge of the cell. The phage staining is very punctate, and the different cell slices show different amounts of phage staining. We had anticipated that the phage staining would look like little villi sticking out from the yeast cell surface, however, the phage appear to be laying on the cell surface. Regardless, the punctate staining appears to match well with the size and shape of phage and it is clear how phage would limit access to the yeast cell surface once bound. We have also observed that, if the α-HA antibody is incubated with Z13e1 yeast cells after incubation with TJ7.15 phage, the α-HA signal is at least an order of magnitude lower by flow cytometry.

To determine the appropriate conditions to select cognate antibody-antigen pairs from two libraries, we spiked Z13e1 yeast into the FDA2 Kappa scFv library at varying:concentrations (1:100, 1:1,000 and 1:10,000). Phage TJ7.15 was also spiked into the gp160 phage-fragment library at the same concentrations. As an example, the 1:100 spiked libraries were subjected to four rounds of selection. The first round of selection was optimized for phage selection, by incubating the phage and yeast libraries, washing unbound phage away with only 2 washes, and eluting bound phage from the yeast cells. The output phage were amplified for the next round of selection. The second round of selection was optimized for selection of yeast cells utilizing a magnetic bead selection protocol. Yeast cells bound to phage were isolated by labeling the phage with an anti-phage mouse monoclonal antibody (α-M13-A546) and capturing the complexes with anti-mouse antibody coated microbeads on a magnetic column. The yeast cells were eluted from the column and amplified for the next round of selection. The third round of selection mixed the output phage from round 1 and output yeast cells from round 2, and then flow cytometry cell sorting was utilized to isolate yeast-phage pairs. Round 4 also utilized flow cytometry cell sorting, and yeast-phage pairs were selected and single cell sorted into 96-well plates. Results obtained from the selection rounds are summarized in the following table.

TABLE 2
Selection of binding pairs from yeast library and phage library

| | | | | | % of scFv |
|---|---|---|---|---|---|
| Selec- | | | | | positive yeast |
| tion | Phage | Phage | Yeast | Yeast | cells binding |
| Round | input | output | input | output | to phage |
| 1 | 2 × 10¹³ | 1 × 10⁷ | 2 × 10⁹ | not | Unknown |
| | | | | collected | |
| 2 | 4 × 10¹¹ | not | 2 × 10⁹ | 1 × 10⁷ | Unknown |
| | | collected | | | |
| 3 | 1 × 10¹¹ | 2.6 × 10⁴ | 2 × 10⁸ | 5 × 10⁶ | 0.6% |
| 4 | 1 × 10¹¹ | not | 1 × 10⁸ | Single | 1.0% |
| | | determined | | cells | |

Since the final selection round must maintain the link between the two display formats, we have developed conditions for single-cell sorting into 96-well microtiter plates. We found that recovery of yeast cells is typically 65-100%, and that after cells are grown for 2 days at 30° C. phage are easily isolated and amplified from 100% of yeast-positive wells. The successful sorting of single yeast cells into microtiter plates and eluting phage from these yeast indicate that the link between the two display platforms was maintained.

### Example 4

### Selecting Binders with Semi-solid Phage Panning/amplification

This Example describes additional experiments performed to enrich binders between yeast displayed scFv antibodies and phage displayed polypeptide antigens. Unlike Example 3, phage amplification was performed in semi-solid growth media instead of liquid growth media. Methods for amplifying phage displayed target molecules in solid or semi-solid phase are well known in the art, e.g., as described in Barbas et al., Phage Display: A Laboratory Manual, Cold Spring Harbor Laboratory Press (2001); and Pistillo et al., Hum Immunol. 57:19-26, 1997. Briefly, the semi-solid panning conditions employed in the present Example are identical to that described in Protocol 10.5 of Barbas et al. with the following exceptions. After phage elution with the glycine buffer, the ER2738 cells were infected and plated on GCSB (glucose/carbenicillin/super broth) agar plates and grown at 30° C. overnight. The cells infected with phage were then scraped from the agar plates into 5 ml of super broth. These cells were then inoculated into 100 ml of Super broth with carbenicillin (50 μg/ml), tetracycline (10 μg/ml) and glucose (2%) at an O.D.₆₀₀ of 0.1. The cells were grown until the O.D.₆₀₀ reaches 0.8 and then VCSM3 helper phage was added at a MOI of 20:1. After two hours of helper phage infection, the cells were centrifuged to remove the glucose. Phage amplification proceeded overnight at 30° C. Unless otherwise noted, all other materials and methods employed in the experiments are the same as that described above.

Similar to Example 3, Z13e1 antibody-displaying yeast were spiked into the FDA2 yeast antibody display library, and TJ7.15 antigen fragment-displaying phage were spiked into the gp160 antigen fragment library at frequencies of either 1:100 or 1:10,000. However, by switching to semi-solid growth for phage panning and amplification, we were able to greatly decrease the number of washes necessary in the first selection round and observed significant enrichment of phage TJ7.15 in a single selection round. Specifically, with the selection conditions optimized we were able to isolate Z13e1 yeast and TJ7.15 phage from 1:100 spiked libraries with only 4 rounds of selection. Ninety percent of the yeast round 4 output was Z13e1 and 75% of the phage round 4 output was TJ7.15. The other 10% of the yeast population was two different clones, one with the same heavy chain as Z13 but an alternative light chain and the second was a truncated scFv. For phage, the remaining 25% of clones did not display protein (sequences contained stop codons prior to geneIII).

With the success of the 1:100 spiked libraries selection, we progressed to the 1:10,000 spiked libraries. These libraries should more closely approximate the frequencies of binding partners one might anticipate in general application of the library vs. library screening approach. The first two rounds of selection enriched the phage antigen library against the 1:10,000 spiked yeast scFv library. After these two rounds approximately 90% of the phage were TJ7.15 as measured by ELISA. The next two rounds of selection utilized flow cytometry sorting to enrich the yeast scFv library. With only these four rounds of selection Z13e1 yeast cells were isolated at a frequency of 20%. The remaining 80% of the yeast scFv bound to the anti-phage fluorescent reagents. In subsequent library selections these scFv can be easily removed from the library with a subtractive pre-sort.

For single-cell sorting to maintain the cognate pair information we found that phage can be eluted from the yeast cells with no problems after a month, and perhaps even longer. We have found between 50 and 300 phage particles per single yeast cell when eluting from the single cell sort.

### Example 5

### A Complete Study of Library-against-library Selection

This Example provides a more detailed description of assay conditions employed in the experiments described in Example 4, results obtained from the studies, and analyses of the data.

### A. General Strategy and Considerations

To determine conditions for selection of cognate antigen-antibody pairs in a library format, both Z13e1 yeast and TJ7.15 phage were spiked into the yeast and phage libraries at a frequency of 1:10⁴, which makes the frequency of the cognate pair 1:10⁸ when the libraries are mixed. In establishing the system for co-selection of replication competent antigen-antibody pairs, several problems appeared that related to: (1) appearance of growth mutants of phage that overtake the selection, (2) phage concentration requirements, (3) optimum fluorescence visualization of phage, (4) conditions for elution of phage from yeast cells that maintain phage and yeast viability, and (5) the need to overcome digestion of phage and/or their expressed antigens by yeast proteases. Ultimately protocols were developed (see below) that addressed all of these problems.

The problem of phage concentration during selections is of particular note and dictates the selection protocol as well as the choice of antibody reagents used to detect phage binding to the yeast cells. Typically during yeast display selections by flow cytometry, the number of antigens that bind to the yeast cell and the resultant antigen binding fluorescence signal is directly proportional to the solution antigen concentration, the affinity of the displayed antibody and the number of displayed antibody molecules per yeast cell. Thus, the concentration of added soluble antigen is adjusted to be greater than or equal to the desired equilibrium binding constants (K_{D}) for the yeast bound antibodies that one wishes to select. The K_{D} of Z13e1 scFv for its antigen is approximately 50 nM. Therefore, to observe strong signals from antigen bound to Z13e1 scFv, the solution antigen concentration should be greater than 50 nM. Standard phage amplification protocols yield a phage concentration of approximately 10¹² phage/mL. If we assume the typical recombinant protein display percentage of 1-10% for phagmid display systems, the solution antigen concentration would be at most 0.1 nM, and the concentration of TJ7.15 in the initial spiked library would be 10 fM. At this phage concentration, phage bind to yeast cells but not at sufficient density for the binding to be visualized by flow cytometry. Thus, the first two rounds of selection were designed to simply increase the concentration in the library of phage that specifically bound to the yeast cells. To accomplish this, the yeast and phage libraries were mixed, unbound phage were washed away, and the bound phage were eluted from the yeast cells and amplified. This step enriches the library about three orders of magnitude for phage that bind specifically to yeast cells expressing antibodies.

The second major consideration concerns the nature of the fluorescent anti-phage antibody used to detect phage binding to yeast cells. One has to balance the need to obtain a high signal-to-noise ratio with the requirement that the detecting antibody not neutralize phage infectivity to a point that precludes its recovery. Given that the pComb3X vector used here has a HA epitope tag inserted between the expressed antigen and phage pIII, one could, in principle, use either anti-phage coat or anti-HA antibodies for detection of yeast cells that bound phage. Fluorescent anti-phage antibodies, which have many binding targets per phage, give a much stronger signal than the anti-HA antibody that only has one HA binding target per phage when the pComb3X vector is used. Also, proximity of the HA tag to the displayed protein may cause the HA tag to be partially occluded when phage are bound to yeast cells. However, the anti-phage antibodies significantly reduce the infectivity of the phage and are, therefore, not suitable for single cell sorting where one needs to recover low numbers of phage by replication. Therefore, two different antibodies are used. Anti-phage antibody is used for the initial selection rounds and anti-HA antibody is used for the final selection when single cells are sorted.

Finally, the elution conditions that disrupt the antigen-antibody mediated phage-yeast union were also found to be critical. In the strategy outlined here, the system only becomes clonal when individual yeast cells bound to their cognate phage bound are sorted as single cells during the final selection round. However, it is at this point where the potential for replication of the partners is at greatest risk because of their low numbers. To successfully recover both yeast and phage, we found that it was necessary to directly sort into glycine elution buffer, immediately centrifuge the plate to pellet the individual yeast cell and collect most of the buffer containing phage. Media is then added to the yeast cells and E. coli are infected with the recovered phage for their respective amplifications. Using this protocol, we recovered an average of 60% of yeast cells with an average of 18 copies of phage bound to their surface. Eighty nine percent of the phage recovered by this procedure bind to the antibody that was displayed on the surface of the yeast cell from which they were eluted. If we immediately elute the phage and then store them at 4° C. before infection we observe an average of 10 copies of viable phage per yeast cell with 98% of the phage binding. At these numbers, both yeast and phage clones were easily recovered.

B. Methods for Selecting Z13e1-TJ7.15 Binding Pairs and Analyzing Identified Binders

Library-versus-Library selections: For the first round of selection, the phage libraries were transformed and amplified using E. coli XL1-Blue in SB with 2% glucose. Tetracycline (tet) was added at 10 μg/ml the first hour after transformation. Carbenicillin (carb) 20 μg/ml was added after the first hour and subsequently increased to 50 μg/ml for the second hour. After an additional hour the culture was expanded to 100 ml and the cells were super-infected with VCSM13 (6×10¹¹ pfu) for 30 min at 37° C. without shaking followed by 90 min at 37° C. at 300 rpm. Cells were centrifuged to remove the glucose containing media and resuspended in 100 mL SB with Carb, Tet, and Kanamycin (kan, 70 μg/mL) and incubated by shaking 16 hours at 30° C. Phage were precipitated on ice for 30 minutes with 4% PEG/3% NaCl, and resuspended in 2 mL 1% BSA/PBS. After selection, the phage were infected into ER cells for 15 minutes and phage-infected cells were plated on LB agar containing 0.5% glucose and incubated at 30° C. overnight. Cells were scraped from the agar plates into 5 ml of SB and added to 100 ml of SB (plus carb, tet and glucose) to an OD₆₀₀ of 0.1. The culture was incubated at 37° C. until the OD₆₀₀ reached 0.8. VCSM13 was added and all subsequent steps were completed as described above. For the later selection rounds cells were scrapped into 1 L instead of 100 mL and all steps were scaled up accordingly, except after precipitation phage were resuspended in 1 mL PBS.

The yeast libraries were grown as described above. Typically, yeast were grown in SD-CAA for approximately 8-16 hours at 30° C. (depending on starting cell density) and then transferred to SG/R-CAA to induce scFv expression for approximately 16-20 hours at 20° C. in culture volumes appropriate for the size of the library.

In the initial selection rounds, 10¹² freshly precipitated phage were panned against 10⁸ freshly induced yeast cells by incubating phage and yeast in 1% BSA/PBS buffer for at least 2 hours at 37° C. Unbound phage were washed away by pelleting the yeast cells, resuspending cells in 2 mL PBST (0.05% Tween-20/PBS) and transferring cells to a new tube. For the first round yeast cells were washed 5 times. In the second round cells were washed 10 times. Any phage still bound to yeast cells were eluted with 200 μL of glycine elution buffer (200 mM glycine, 1 mg/ml BSA, 0.05% Tween-20, pH 2.2). The buffer containing phage was neutralized with 12 μl 2M TRIS base, after which ER cells were infected for phage amplification as described above.

For flow cytometry selections, 10⁸ yeast cells were incubated with 20 μg/mL anti-cmyc-Alexa647 in 100 μL WB for 15 minutes at room temperature. Freshly precipitated phage from a 1 L culture were pre-blocked with 300 μL 20% milk for 15 minutes at room temperature and then added to the yeast cells. Yeast and phage were incubated at room temperature for 2 hours followed by 10 minutes at 4° C. All remaining steps were carried out at 4° C. Yeast cells were washed five times with 2 mL WBT (0.05% Tween-20/wash buffer). Yeast cells were transferred to a new tube with each wash, and then incubated with freshly labeled anti-phage/Zenon-PE at 15 μg/mL for 1 hour. The anti-phage/Zenon-PE was prepared according to the manufacture's directions. The cells were washed three times with 2 mL WB and then selections were performed using a BD Bioscience FACS Aria. Sort gates were determined to select the desired double positive cells. After the first flow cytometry selection only the yeast cells were amplified. For subsequent rounds the collected yeast cells were split in half, with half of the yeast cells amplified and the other half mixed with 50 μL TEA (triethylamine, 100 mM, freshly prepared) for 1 minute. Yeast cells were centrifuged and the TEA was removed and neutralized with 25 μL of 1M TRIS-HCl, pH 7.6, before infecting ER cells to amplify the phage.

For the final selection round yeast cells were sorted into 96-well plates containing 50 μL of glycine elution buffer. The plates were immediately centrifuged and ˜45 μL of buffer was removed with care so as to not pipette the single yeast cell and the solution was neutralized with 4 μL 2M TRIS. The phage can either be mixed with ER cells immediately or stored at 4° C. prior to infection. Phage from each well were plated onto separate agar plates, grown overnight at 37° C. after which the plates were stored at 4° C.

SD-CAA media (100 μL) was added to the yeast cells and they were grown at 30° C. for 2 days. After the single yeast cells had replicated, the cells from each well were grown in 1 mL SD-CAA media overnight at 30° C. The vector contained in the yeast cells was isolated using a Zymoprep yeast miniprep kit (Zymo Research). Each scFv sequence was amplified by PCR and unique clones were identified by BstNI digestion and their sequence was determined. Once unique yeast clones were identified, the cognate phage were retrieved from the stored plates and grown overnight at 37° C. in 500 μL SB/carbNCSM13. The phage-containing supernatant was used to analyze specific phage-yeast binding by whole-cell ELISA.

Phage ELISA: ELISA plates were coated overnight at 4° C. with 25 μL PBS containing 4 μg/mL of the coating antibody (Z13e1 IgG, 2F5 IgG, or anti-HA). Wells were washed twice with PBST and blocked with 50 μL 5% milk for 30 min at 37° C. Phage supernatant (25 μL) or 2-fold dilution series of precipitated phage (25 μl) was added to each well and incubated for 2 hours at 37° C. Wells were washed 4 times with PBST and then 25 μL anti-phage-HRP (diluted 1:1000 in 5% milk) was added to each well and incubated for 1 hour at 37° C. Wells were again washed 4 times with PBST and 50 μl of ABTS developer (450 μg/mL ABTS/0.01% H₂O₂/100 mM citrate buffer, pH 4.0) was added. After 30 minutes at RT the OD₄₀₅ was measured on a microplate reader (Molecular Devices).

Whole-Cell ELISA: Yeast cells (2×10⁶) were mixed with 100 μL of phage supernatant for 2 hours at 37° C. Yeast cells were washed 3 times with WBT and then incubated with 50 μL anti-HA-HRP (1:1000 dilution in 5% milk/PBS) for 1 hour at 37° C. Yeast cells were washed again three times and moved into new tubes for the final wash then resuspended in 200 μL of ABTS developer. After 30 min at RT cells were centrifuged and 50 μL of supernatant was transferred to ELISA plate and the oD₄₀₅ was measured.

C. Recovery and Characterization of Identified Clones from Single Cell Sorts

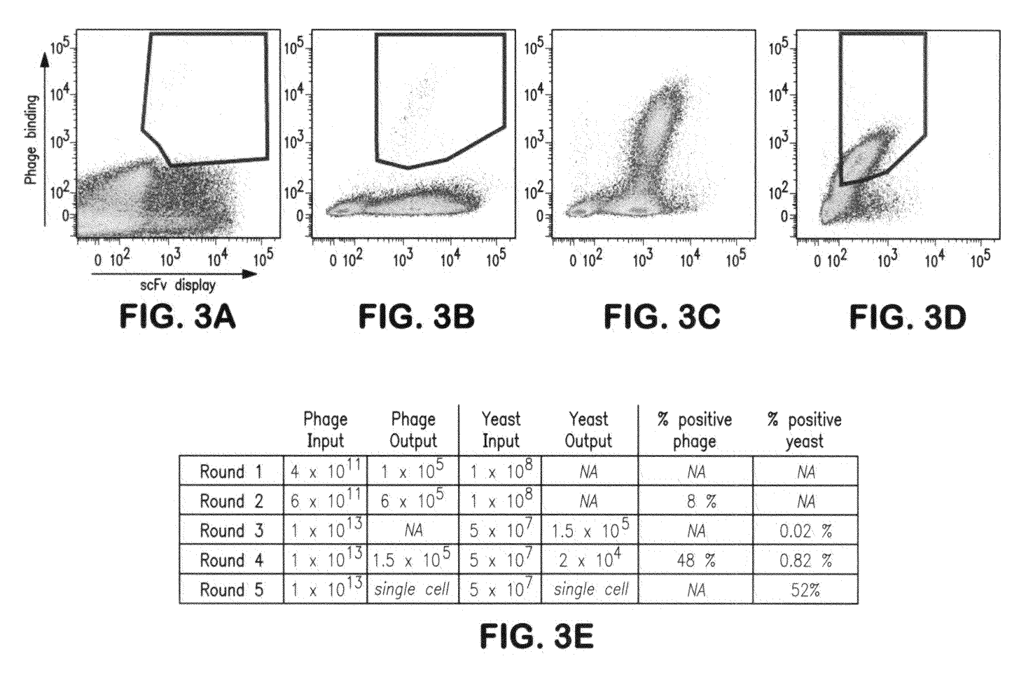

When the conditions described above were used, we were able to successfully enrich for the Z13e1-TJ7.15 pair with only five rounds of sorting. In FIG. 3, the results of a protocol in which successful selection of the Z13e1-TJ7.15 pair was accomplished are summarized. Panels A and B show flow cytometry plots from selection rounds 3 and 4 respectively, with the sort gate for selection indicated in blue. Panels C and D are both from round 5 but utilize different fluorescence markers. Panels A-C utilized anti-c-myc-Alexa647 for scFv visualization and anti-phage/Zenon-PE for phage binding, (the phage negative population appear different because they were obtained on two separate instruments with different voltage settings). Panel D utilized anti-c-myc-Alexa488 for scFv visualization and anti-HA-Alexa647 for phage binding. Panel E summarizes the input and output titers for both phage and yeast for each selection round and the percentage of phage and yeast that are positive for the desired Z13e1-TJ7.15 antibody-antigen pair. The percentage of positive phage was determined by phage ELISA for 48 clones after each round. The percentage of positive yeast cells was calculated by determining the percent of scFv positive yeast cells that bound to phage during the flow cytometry selection; this number actually reflects the percentage of double positive yeast cells that are input into the selection round, not the output from that round.

Thus, the results obtained from the experiments indicate that, after the round 5 amplification, 100% of yeast clones analyzed were Z13e1 and 88% of the analyzed phage were TJ7.15. Although we utilized an HIV gp160 fragment library and an HIV patient antibody library we did not isolate any additional pairs. This is not unexpected because it is well established that the majority of patient antibodies against HIV envelope proteins bind to discontinuous and conformational epitopes. Indeed, previous studies of the antibody library studied here showed that it contained few, if any, antibodies to linear protein sequences other than those contained in the TJ7.15 epitope.

Given the potential numbers of cognate pairs that could be identified by this selection method, it is critical to have a high through put means of characterizing the isolated pairs. To accomplish this, we first analyzed the yeast antibodies by BstNI digestion to identify unique clones and verified the nature of the insert by DNA sequencing. Then the cognate phage were grown and whole cell ELISA was utilized to verify that they bound to the specific scFv-yeast and representative phage clones were sequenced. All phage that bound Z13e1-yeast by ELISA were confirmed to be TJ7.15 by sequencing. This analysis can be applied to a large number of clones simultaneously with sequences easily determined within two weeks of the final selection round. A small proportion (12%) of phage clones did not bind to Z13e1-yeast and were of unknown origin. These clones could not be sequenced using any pComb3X sequence primers, perhaps because the vector had recombined but still maintained carb-resistance.

Although the foregoing invention has been described in some detail by way of illustration and example for purposes of clarity of understanding, it will be readily apparent to one of ordinary skill in the art in light of the teachings of this invention that certain changes and modifications may be made thereto without departing from the spirit or scope of the appended claims.

All publications, databases, GenBank sequences, patents, and patent applications cited in this specification are herein incorporated by reference as if each was specifically and individually indicated to be incorporated by reference.

What is claimed is:

1. A method for identifying a pair of binding partners from two libraries of candidate biomolecules, comprising (a) display a first library of candidate biomolecules in a first library of replicable genetic package; (b) display a second library of candidate biomolecules in a second library of replicable genetic package; (c) contacting the first library of replicable genetic package with the second library of replicable genetic package; and (d) identifying at least one member of the first library of replicable genetic package to which a member of the second replicable genetic package inbound.

2. The method of claim 1, wherein each library of candidate biomolecules comprises at least 10, 10², 10³, 10⁴, 10⁵, 10⁶, 10², or 10⁸ members.

3. The method of claim 1, wherein the libraries of candidate biomolecules are polypeptides.

4. The method of claim 3, further comprising determining nucleotide sequences of polynucleotides which encode the polypeptides expressed in the identified members of the replicable genetic packages.

5. The method of claim 3, wherein the libraries of candidate biomolecules are expressed as fusion proteins to a package surface protein.

6. The method of claim 3, wherein the first replicable genetic package is a cell based display platform, and the second replicable genetic package is a non-cell based display platform.

7. The method of claim 6, wherein the first library of replicable genetic package is a yeast surface display library, and the second library of replicable genetic package is a phage display library.

8. The method of claim 7, wherein the phage is a filamentous phage.

9. The method of claim 8, wherein the filamentous phage is selected from the group consisting of M13, fd and fl.

10. The method of claim 3, wherein one library of candidate polypeptides is a library of antibodies or antigen-binding fragments, and the other library of candidate polypeptides is a library of antigens.

11. The method of claim 10, wherein the library of antibodies or antigen-binding fragments comprises single chain variable region fragments (scFvs), single domain antibodies (dAbs), Fab fragments, F(ab′)₂ fragments, Fv fragments or Fd fragments.

12. The method of claim 10, wherein the library of antigens is displayed in a yeast display platform, and the library of antibodies is displayed in a phage display platform.

13. The method of claim 10, wherein the library of antibodies is displayed in a yeast display platform, and the library of antigens is displayed in a phage display platform.

14. The method of claim 10, wherein the library of antibodies comprises a library of human antibodies.

15. The method of claim 14, wherein the library of human antibodies comprises a naïve human antibody library.

16. The method of claim 10, wherein the library of antibodies comprises a library of murine antibodies.

17. The method of claim 16, wherein the library of murine antibodies comprises a naïve murine antibody library

18. The method of claim 10, wherein the library of antigens comprise antigens from bone marrow cells.

19. The method of claim 18, wherein the library of antigens are encoded by a cDNA library from bone marrow cells.

20. The method of claim 10, wherein the library of antigens comprise antigens from a tumor cell.

21. The method of claim 20, wherein the library of antigens are encoded by a cDNA library from the tumor cell.

22. The method of claim 20, wherein the library of antigens are encoded by a cDNA library encoding surface proteins of the tumor cell.

23. A screening system for identifying binding partners, comprising (a) a first library of candidate biomolecules displayed in a first replicable genetic package; and (b) a second library of candidate biomolecules displayed in a second replicable genetic package.

24. The screening system of claim 23, wherein each library of candidate biomolecules comprises at least 10, 10², 10³, 10⁴, 10⁵, 10⁶, 10⁷, or 10⁸ members.

25. The screening system of claim 23, wherein the libraries of candidate biomolecules are polypeptides.

26. The screening system of claim 23, wherein the first library of candidate biomolecules are antibodies or antigen-binding fragments, and the second libraries of candidate biomolecules are antigens.

27. The screening system of claim 23, wherein the first library of candidate biomolecules are single chain variable region fragments (scFvs), single domain antibodies (dAbs), Fab fragments or F(ab′)₂ fragments.

28. The screening system of claim 23, wherein the first library of candidate biomolecules are naïve human single chain antibodies.

29. The screening system of claim 23, wherein the second library of candidate biomolecules are antigens encoded by a cDNA library of bone marrow cells.

30. The screening system of claim 23, wherein the second library of candidate biomolecules are antigens encoded by a cDNA library of a tumor cell.

31. The screening system of claim 23, wherein one of replicable genetic packages is phage, and the other replicable genetic package is yeast.

32. A kit comprising (a) a first vector for displaying a first library of candidate biomolecules in a first replicable genetic package; and (b) a second vector for display a second library of candidate biomolecules in a second replicable genetic package.

33. The kit of claim 32, further comprising an instruction for selecting the first library against the second library to identify binding partners.

34. The kit of claim 33, wherein the instruction comprises a protocol for contacting the first library with the second library, a protocol for identifying a member of the first library specifically bound by a member of the second library, and a protocol for separating the bound members.

35. The kit of claim 32, further comprising a first host cell for expressing the first vector and a second host cell for expressing the second vector.

36. The kit of claim 32, wherein the libraries of candidate biomolecules are polypeptides.

37. The kit of claim 36, wherein the first library of candidate biomolecules are antibodies or antigen-binding fragments, and the second libraries of candidate biomolecules are antigens.

38. The kit of claim 36, wherein the first library of candidate biomolecules are single chain variable region fragments (scFvs), single domain antibodies (dAbs), Fab fragments or F(ab′)₂ fragments.

39. The kit of claim 32, wherein the first replicable genetic package is phage display, and the second replicable genetic package is yeast display.

40. The kit of claim 39, wherein the first vector is a phagemid vector, and the second vector is yeast surface display vector.
